(19) United States
(12) Patent Application Publication
(10) Pub. No.: US 2026/0015136 A1
(43) Pub. Date: Jan. 15, 2026

(54) DISPENSER AND DISPENSING DEVICE COMPRISING CONTAINER

(71) Applicant: LG H&H CO., LTD., Seoul (KR)

(72) Inventors: In Sun Lee, Seoul (KR); Kyung Won Kim, Seoul (KR); Jae Koan Yoon, Seoul (KR); Jong Hyuk Kim, Seoul (KR)

(21) Appl. No.: 18/881,193

(22) PCT Filed: Jun. 29, 2023
(86) PCT No.: PCT/KR2023/009160

§ 371 Date: Jan. 3, 2025

(30) Foreign Application Priority Data
Jul. 5, 2022 (KR) 20-2022-0001634

(51) Int. Cl. B65D 47/20

(52) U.S. Cl. CPC B65D 47/2068

(57) ABSTRACT

A dispenser according to an embodiment of the present disclosure includes an outer cap fastened to an inlet of a container capable of increasing internal pressure by an external force and having a nozzle discharging contents contained in the container; a support portion having a plurality of support columns spaced apart from each other around the nozzle in the outer cap; an inertial member guided by the plurality of support columns, moving toward the nozzle when the internal pressure of the container increases, and opening and closing the nozzle; and an elastic member pushing the inertial member away from the nozzle, wherein a first inflow path is formed by a space between the plurality of support columns in a discharge direction of the nozzle, and wherein the first inflow path is configured to allow the contents to press the inertial member when the internal pressure of the container increases.

### TECHNICAL FIELD

The present invention relates to a dispensing apparatus containing a dispenser and a container, and more particularly, to a dispenser a container in which liquid contents are discharged to the outside in an appropriate amount by pressurizing the container in an inverted state of the container in which the liquid contents are contained.

### BACKGROUND ART

In general, liquid contents such as liquid cosmetics, cream cosmetics, powder cosmetics, liquid medicines, liquid detergents, body products such as liquid shampoos and conditioners, liquid food such as porridge, and paints are stored in a container and used by discharging an appropriate amount whenever necessary.

In order to discharge an appropriate amount of such liquid content, a dispenser is installed at the inlet of the container.

The dispenser is configured to be capable of ejecting the contents in a state in which the container is erected, or ejecting the content in a state in that the container is inverted.

Various means for discharging an appropriate amount of such a dispenser are being researched and developed, and in addition, research is continuously being conducted to improve user convenience while reducing manufacturing costs.

### DISCLOSURE

### Technical Problem

The present invention has been invented to solve the above-described problems of the prior art, and an object the present invention is to provide a dispensing apparatus containing a dispenser and a container that can smoothly discharge liquid contents while discharging an appropriate amount, and can simplify components to reduce manufacturing costs.

### Technical Solution

A dispenser according to one aspect of the present invention may include an outer cap fastened to an inlet of a container capable of increasing internal pressure by an external force and having a nozzle discharging contents contained in the container: a support portion having a plurality of support columns spaced apart from each other around the nozzle in the outer cap: an inertial member guided by the plurality of support columns, moving toward the nozzle when the internal pressure of the container increases, and opening and closing the nozzle; and an elastic member pushing the inertial member away from the nozzle, wherein a first inflow path may be formed by a space between the plurality of support columns in a discharge direction of the nozzle, and wherein the first inflow path may be configured to allow the contents to press the inertial member when the internal pressure of the container increases.

Specifically, a second flow path may be formed by a space between the plurality of support columns in a circumferential direction of the nozzle, and wherein the second flow path may allow the contents to flow between the inertial member and the nozzle when the inertial member moves away from the nozzle by the elastic member, or may allow the contents to flow into the nozzle by a siphon effect when the inertial member moves toward the nozzle when compressing the elastic member.

Specifically, the nozzle may include a discharge port protruding toward an outside of the container and an inlet protruding toward an inside of the container, the inertial member may include a plug portion moving toward the nozzle to contact the inlet and close the nozzle, the plug portion may have a shape in which cross-section becomes smaller in a direction toward the nozzle, and the inlet may have a shape corresponding to the shape of the plug portion.

Specifically, a discharge amount of the contents may be adjusted by adjusting a distance between the plug portion and the nozzle, and the discharge amount of the contents may become greater when the distance between the plug portion and the nozzle becomes greater.

Specifically, the distance between the plug portion and the nozzle may be adjusted according to a length of the plug portion or a length of the plurality of support columns.

Specifically, the inertial member may include a cylindrical main body portion having one side facing the nozzle being open and an other side facing the container being closed, a guide portion provided on an outer peripheral surface of the main body portion to correspond to the plurality of support columns, a plug portion having a shape in which a cross-section becomes smaller in a direction from the main body portion toward the nozzle, and a groove portion provided on an other side surface of the main body portion and having a shape corresponding to the cross-section of the plug portion.

Specifically, the inertial member may further include at least one of an auxiliary guide portion guiding an ascending and descending of the support column and a protrusion increasing a surface area to which the contents press when the internal pressure of the container increases, wherein the auxiliary guide portion may have a rod shape extending in a longitudinal direction of the support column in the guide portion, and wherein the protrusion may protrude from the outer peripheral surface of the main body portion and may have a groove on a side facing the container.

Specifically, the main body portion may have a discontinuous cylindrical shape in which a portion corresponding to the plurality of support columns is cut out, wherein the guide portion may be provided on an edge of the closed other side of the main body portion to minimize friction with the plurality of support columns during a vertical movement of the inertial member, and wherein the protrusion may extend from one end to an other end of the main body portion to compensate for a strength of the main body having the discontinuous cylindrical shape.

Specifically, the plurality of support columns may be formed of four columns by providing one at each vertex of a rectangle or formed of three columns by providing one at each vertex of a triangle.

Specifically, the support portion may be integrally formed with the outer cap, and may include a stopper provided on an end of at least one of the plurality of support columns facing each other, and the stopper may be implemented in a heat fusion or an injection and may prevent the inertial member from disengaging when the inertial member moves away from the nozzle by the elastic member.

Specifically, the support may be integrally formed with the outer cap, and the support portion may include the plurality of support columns spaced apart from each other around the nozzle in an inner side of the outer cap, a locking groove provided concavely in at least a portion of an inner side surface of an end of the plurality of support columns facing each other, and a buffer groove formed by cutting the end of the plurality of support columns with the locking groove to a predetermined depth.

Specifically, the dispenser may further include a stopper member preventing the inertial member from being detached when the elastic member moves away from the nozzle, wherein the stopper member may include an annular portion having a ring shape corresponding to the inertial member and in contact with the inertial member, a plurality of fixing portions protruding outwardly from positions corresponding to the plurality of support columns to an outside of the annular portion so that the annular portion is fixed to the plurality of the support columns, a locking jaw protruding outwardly from the fixing portion and inserted into the locking groove at a position corresponding to the support column in which the locking groove is provided among the plurality of support columns, and a hole including a plurality of holes and through which a portion of the annular portion in which the plurality of fixing portions are located penetrates, wherein the plurality of holes allow the contents to pressurize the inertial member when the internal pressure of the container increases.

Specifically, the dispenser may further include a discharge member coupled to the nozzle to discharge the contents passing through the nozzle to the outside, wherein the discharge member may include a coupling portion coupled to the nozzle, a discharge portion extending outwardly from the coupling portion by a predetermined length to discharge the contents to the outside, and a valve portion opened when the container is pressurized and closed when the container is released.

Specifically, the valve portion may include a silicon valve or a disk valve, wherein the silicon valve is used when the contents have a low viscosity and a required discharge amount is small, and wherein the disk valve is used when the contents have a high viscosity and the discharge amount is large.

A dispenser according to another aspect of the present invention may include: an outer cap fastened to an inlet of a container capable of increasing internal pressure by an external force and having a nozzle discharging contents contained in the container: a support portion provided around the nozzle in the outer cap: an inertial member moving toward the nozzle when the internal pressure of the container increases, and opening and closing the nozzle; and an elastic member pushing the inertial member away from the nozzle, wherein the support portion may include a fourth fastening portion provided on an outer peripheral surface and fastened to the outer cap; and a plurality of inflow paths formed by penetrating the outer peripheral surface at regular intervals in a circumferential direction of the nozzle.

Specifically, the outer cap may include a second fastening portion fastened to a first fastening portion of the container, and a third fastening portion provided between the second fastening portion and the nozzle and fastened to the fourth fastening portion of the support portion.

Specifically, the nozzle may include a discharge port protruding toward an outside of the container, and an inlet protruding toward an inside of the container, the inertial member may include a plug portion moving toward the nozzle to contact the inlet and close the nozzle, the plug portion may have a shape in which a cross-section becomes smaller in a direction toward the nozzle, and the inlet may have a shape corresponding to the shape of the plug portion.

Specifically, the inertial member may include a main body portion having a cylindrical shape in which one side facing the nozzle and the other side facing the container are open, the main body portion being divided into a first portion facing the nozzle and a second portion facing the inside of the container, a guide portion provided on an inner peripheral surface of the first portion of the main body portion to guide movement of the body portion with respect to the nozzle, a plug portion provided in the main body portion between the first portion and the second portion, the plug portion having a shape in which a cross-section becomes smaller in a direction toward the nozzle, and a groove portion having a shape corresponding to a cross-section of the plug portion in the second portion.

Specifically, the plurality of inflow paths of the support portion may be configured to allow the contents to be introduced into the first portion when the inertial member moves away from the nozzle by the elastic member, or the contents to be transferred to the nozzle by a siphon effect when the inertial member moves toward the nozzle while compressing the elastic member.

Specifically, the support portion, the inertial member, and the elastic member may be integrally formed of one material.

Specifically, the elastic member may be provided on an outer periphery of the inertial member, and one end of the elastic member may be connected to the support portion and an other end may be connected to the inertial member.

A dispenser according to another aspect of the present invention may include: an outer cap fastened to an inlet of a container capable of increasing internal pressure by an external force and having a nozzle discharging contents contained in the container: a housing provided in the outer cap and around the nozzle; an inertial member moving toward the nozzle in the housing when the internal pressure of the container increases and opening and closing the nozzle; and an elastic member pushing the inertial members away from the nozzle, wherein the housing may include: a fourth fastening portion provided at an end of an outer peripheral surface and fastened to the outer cap; a first inflow path provided on an opposite side of the nozzle with respect to the inertial member and provided to allow the contents to flow from an outside of the housing to an inside by increasing the internal pressure of the container to press the inertial member; and a plurality of second inflow paths provided on one side of the inertial member facing the nozzle and provided with the outer peripheral surface cut at regular intervals in a circumferential direction of the nozzle.

Specifically, the second inflow path may allow the contents to flow into the housing when the inertial member moves away from the nozzle by the elastic member, or may allow the contents to be transferred to the nozzle by a siphon effect when the inertial member moves toward the nozzle while compressing the elastic member.

Specifically, the nozzle may be provided with a discharge port protruding toward an outside of the container and an inlet protruding toward an inside of the container, the inertial member may be provided with a plug portion contacting the inlet and closing the nozzle when moving toward the nozzle, the plug portion may have a shape in which a cross-section becomes smaller in a direction toward the nozzle, and the inlet may have a shape corresponding to the shape of the plug portion.

Specifically, the inertial member may include a cylindrical main body portion in which one side facing the nozzle is open and an other side facing the container is closed: a plug portion having a shape in which a cross-section becomes smaller in a direction from the main body portion toward the nozzle; and a groove portion having a shape corresponding to the cross-section of the plug portion on an other side surface of the main body portion.

Specifically, the inertial member may further include: a rib extending along an edge of the other side of the main body portion to face the container for a predetermined length to minimize friction when ascending and descending in the housing; and a plurality of protrusions protruding on an outer peripheral surface of the main body portion to increase a surface area to which the contents accommodated in the container press when the internal pressure of the container increases, wherein the rib guides movement of the main body portion with respect to the housing, and the plurality of protrusions are provided to be inserted into the second inflow path of the housing, and may have a hemispherical shape having a groove on a side facing the container.

Specifically, the outer cap may include: a second fastening portion fastened to a first fastening portion of the container; and a third fastening portion provided between the second fastening portion and the nozzle and fastened to the fourth fastening portion in the housing, wherein the first fastening portion and the second fastening portion may have a screw fastening structure, and the third fastening portion and fourth fastening portion may have an undercut fastening structure.

A dispensing apparatus according to another aspect of the present invention may include the above-described dispenser a container mounted to the dispenser.

Specifically, the dispensing apparatus may include contents contained in the container.

### Advantageous Effects

A dispensing apparatus containing a dispenser and a container according to the present invention can discharge not only the liquid content in an appropriate amount, but also discharge the liquid content smoothly by forming a siphon line with the surrounding components in a process in which the inertial member that moves toward the nozzle for discharging the liquid content and closes the nozzle moves toward the nozzle when the internal pressure of the container increases.

In addition, the dispensing apparatus containing the dispenser and the container according to the present invention can reduce the manufacturing cost by simplifying components.

### DESCRIPTION OF DRAWINGS

FIGS. 1(a) and 1(b) are perspective views of a dispensing apparatus containing a dispenser and a container according to embodiments of the present invention.

FIG. 2 is a cross-sectional view of a dispensing apparatus containing a dispenser and a container according to first embodiments of the invention.

FIG. 3 is a first perspective view of the dispensing apparatus containing the dispenser and the container according to the first embodiments of the invention.

FIG. 4 is a second perspective view of the dispensing apparatus containing the dispenser and the container according to the first embodiments of the invention.

FIG. 5 is an exploded perspective view of the dispensing apparatus containing the dispenser and the container according to the first embodiments of the present invention.

FIG. 6 is a perspective view for explaining an outer cap and a support portion of the dispenser in the dispensing apparatus containing the dispenser and the container according to the first embodiments of the present invention.

FIG. 7 is a perspective view for explaining an inertial member of the dispensing apparatus containing the dispenser and the container according to the first embodiments of the present invention.

FIG. 8 is a diagram for explaining a use state of the dispensing apparatus containing the dispenser and the container according to the first embodiments of the present invention.

FIGS. 9(a) and 9(b) are perspective views for explaining another embodiment of the inertial member shown in FIG. 7.

FIGS. 10(a) and 10(b) are perspective views for explaining yet another embodiment of the inertial member shown in FIG. 7.

FIGS. 11 and 12 are perspective views for explaining another embodiment of the support portion shown in FIGS. 4 and 6.

FIG. 13 is a perspective view for explaining a stopper applied to the support portion of another embodiment shown in FIGS. 11 and 12.

FIG. 14 is a cross-sectional view of a dispensing apparatus containing a dispenser and a container according to second embodiments of the invention.

FIG. 15 is a first perspective view of the dispensing apparatus containing the dispenser and the container according to the second embodiments of the invention.

FIG. 16 is a second perspective view of the dispenser in the dispensing apparatus containing the dispenser and the container according to the second embodiments of the invention.

FIG. 17 is an exploded perspective view of the dispensing apparatus containing the dispenser and the container according to the second embodiments of the present invention.

FIG. 18 is a perspective view for explaining an outer cap of the dispenser in the dispensing apparatus containing the dispenser and the container according to the second embodiments of the present invention.

FIG. 19 is a perspective view for explaining a support portion, an inertial member, and an elastic member of the dispensing apparatus containing the dispenser and the container according to the second embodiment of the present invention.

FIG. 20 is a diagram for explaining a use state of the dispensing apparatus containing the dispenser the container according to the second embodiments of the present invention.

FIG. 21 is a cross-sectional view of a dispensing apparatus containing a dispenser and a container according to third embodiments of the present invention.

FIG. 22 is a first perspective view of the dispensing apparatus containing the dispenser and the container according to the third embodiments of the invention.

FIG. 23 is a second perspective view of the dispenser, in the dispensing apparatus containing the dispenser and the container according to the third embodiments of the invention.

FIG. 24 is an exploded perspective view of the dispensing apparatus containing the dispenser and the container according to the third embodiments of the present invention.

FIG. 25 is a perspective view for explaining an outer cap of the dispenser in the dispensing apparatus containing the dispenser and the container according to the third embodiments of the present invention.

FIG. 26 is a perspective view for explaining an inertial member of the dispenser in the dispensing apparatus containing the dispenser and the container according to the third embodiments of the present invention.

FIG. 27 is a diagram for explaining a use state of the dispensing apparatus containing the dispenser and the container according to the third embodiments of the present invention.

FIG. 28 is a cross-sectional perspective view of a dispensing apparatus containing a dispenser and a container according to fourth embodiments of the present invention.

FIG. 29 is a perspective view of the dispensing apparatus containing the dispenser and the container according to the fourth embodiments of the present invention.

FIG. 30 is an exploded perspective view of the dispensing apparatus containing the dispenser and the container according to the fourth embodiments of the present invention.

FIG. 31 is a perspective view for explaining an outer cap and a support portion of the dispenser in the dispensing apparatus containing the dispenser and the container according to the fourth embodiments of the present invention.

FIG. 32 is a perspective view for explaining an inertial member of the dispenser in the dispensing apparatus containing the dispenser and the container according to the fourth embodiments of the present invention.

FIGS. 33(a), 33(b), and 33(c) are views for explaining various embodiments of a discharge member of FIG. 30.

FIG. 34 is a cross-sectional perspective view of a dispensing apparatus containing a dispenser and a container according to fifth embodiments of the present invention.

FIG. 35 is a perspective view of the dispensing apparatus containing the dispenser and the container according to the fifth embodiments of the present invention.

FIG. 36 is an exploded perspective view of the dispensing apparatus containing the dispenser and the container according to the fifth embodiments of the present invention.

FIG. 37 is a perspective view for explaining an outer cap and a support portion of the dispenser in the dispensing apparatus containing the dispenser and the container according to the fifth embodiments of the present invention.

FIG. 38 is a perspective view for explaining an inertial member of the dispensing apparatus containing the dispenser and the container according to the fifth embodiments of the present invention.

[Modes of the Invention]

The objects, particular advantages, and novel features of the invention will become more apparent from the following detailed description and the preferred embodiments, which are in connection with the accompanying drawings. In the specification, it should be noted that reference numerals are added to the components in each drawing, so that the same components have the same numerals as much as possible, even if they are shown in other drawings. In addition, in describing the present invention, if it is determined that a specific description of the related known art may unnecessarily obscure the gist of the present invention, a detailed description thereof will be omitted.

Hereinafter, preferred embodiments of the present invention will be described in detail with reference to the accompanying drawings.

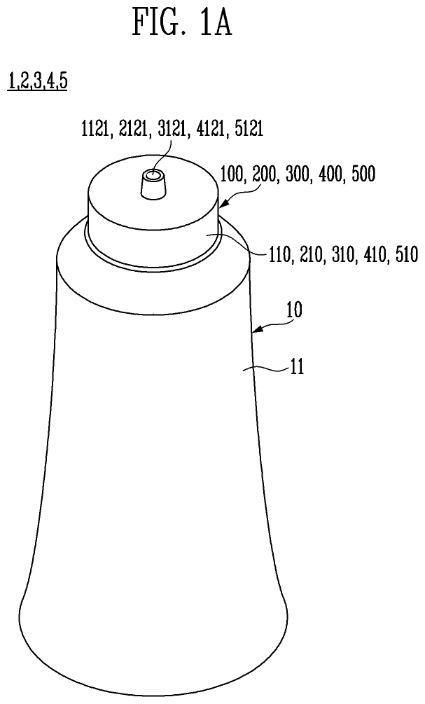

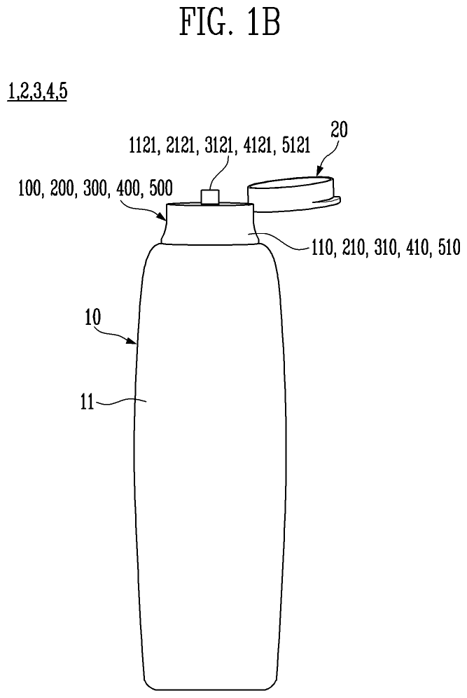

FIGS. 1(a) and 1(b) are perspective views of a dispensing apparatus containing a dispenser and a container according to embodiments of the present invention.

Referring to FIGS. 1(a) and 1(b), dispensing apparatuses 1, 2, 3, 4, 5 according to embodiments of the present invention may include dispensers 100, 200, 300, 400, 500 according to the first, second, third, fourth, fifth embodiments to be described later and a container 10 mounted on the dispenser.

The dispensers 100, 200, 300, 400, and 500 pressurize the container 10 in a state in which the container 10 is inverted so that the liquid content is discharged through discharge ports 1121, 2121, 3121, 4121, and 5121 of nozzles 112, 212, 312, 412, and 412. The discharge ports 1121, 2121, 3121, 4121, and 5121 may be opened/closed with the cap 20. As shown in FIG. 1(b), the cap 20 may be a one-touch cap connected to outer caps 110, 210, and 310 for convenience of use and improvement of circulation and the shape of the cap 20 is not limited thereto.

However, as in the fourth and fifth embodiments to be described later, when nozzles 412 and 512 are combined with separate discharge members 450 and 550 for use, the cap 20 may be omitted and the shape of the cap 20 may be modified to fit the discharge members 450 and 550 even when the cap 20 is applied.

In addition, dispensing apparatuses 1, 2, 3, 4, and 5 according to embodiments of the present invention may include liquid contents accommodated in the container 10.

As described above, the container 10 may contain liquid contents, may increase internal pressure by external force, and may be fastened at the inlet with the dispensers 100, 200, 300, 400, 500 according to the first, second, third, fourth, and fifth embodiments to be described later.

The container 10 may include a container body 11 having a space and an inlet for accommodating liquid contents in an internal space, and a first fastening portion 12 provided on an inner peripheral surface of the inlet so as to be fastened to the dispensers 100, 200, 300, 400, 500 according to the first, second, third, fourth, and fifth embodiments to be described later.

The container body 11 may include a material that is pressed by a user to discharge liquid content to the outside. The container body 11 may include a material having soft elasticity, such as plastic or resin. The container body 11 may have a shape easy to manufacture by blowing or injection and may have various external shapes suitable for squeeze. The container body 11 may include any material as long as it has elasticity depending on embodiments.

The first fastening portion 12 may be a screw fastening structure and may have various fastening structures such as, but not limited to, a snap fastening structure.

As described above, the liquid content may include various materials such as liquid cosmetics, cream cosmetics, powder cosmetics, liquid medicines, liquid detergents, body products such as liquid shampoos and conditioners, liquid food such as porridge, and paints that may be discharged and used.

Hereinafter, the dispensing apparatus 1, 2, 3, 4, and 5 including the dispensers 100, 200, 300, 400, and 500 and the container 10 according to the first, second, third, fourth, and fifth embodiments of the present invention will be described in detail with reference to the accompanying drawings.

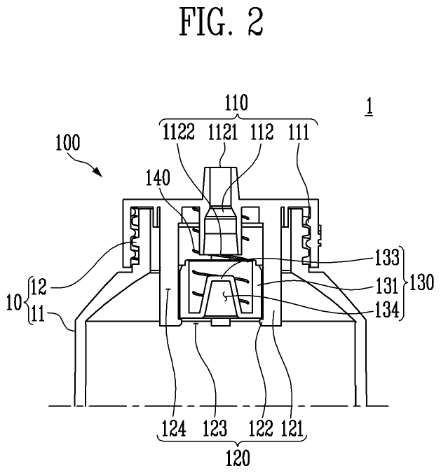

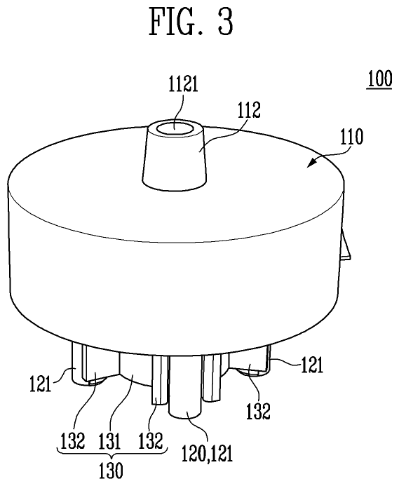

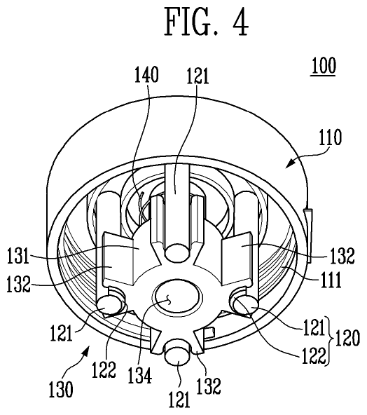

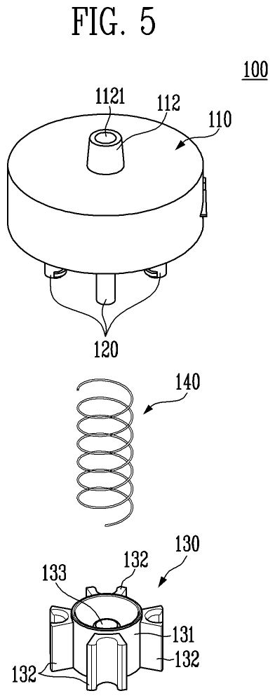

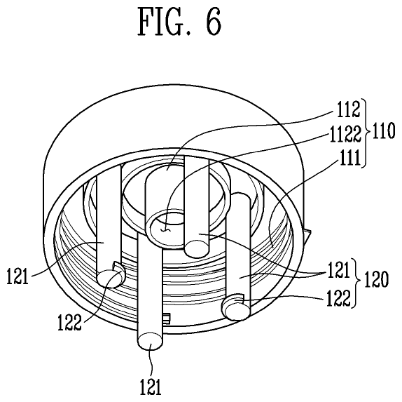

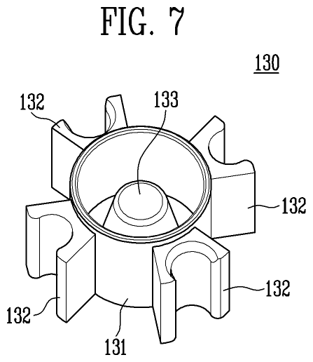

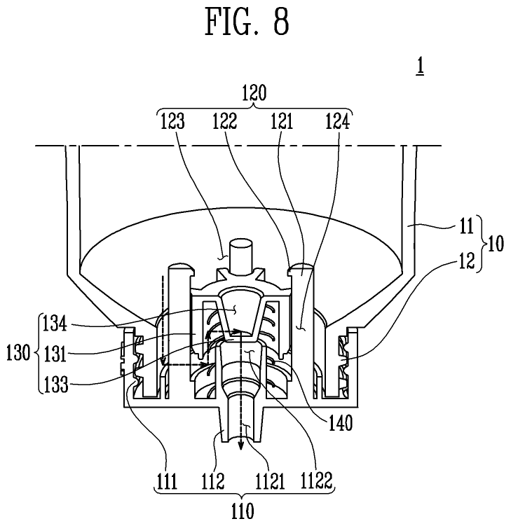

FIG. 2 is a cross-sectional view of a dispensing apparatus containing a dispenser and a container according to first embodiments of the invention, FIG. 3 is a first perspective view of the dispensing apparatus containing the dispenser and the container according to the first embodiments of the invention, FIG. 4 is a second perspective view of the dispensing apparatus containing the dispenser and the container according to the first embodiments of the invention, FIG. 5 is an exploded perspective view of the dispensing apparatus containing the dispenser and the container according to the first embodiments of the present invention, FIG. 6 is a perspective view for explaining an outer cap and a support portion of the dispenser in the dispensing apparatus containing the dispenser and the container according to the first embodiments of the present invention, FIG. 7 is a perspective view for explaining an inertial member of the dispensing apparatus containing the dispenser and the container according to the first embodiments of the present invention, and FIG. 8 is a diagram for explaining a use state of the dispensing apparatus containing the dispenser and the container according to the first embodiments of the present invention.

Referring to FIGS. 2 to 8, the dispensing apparatus 1 according to the first embodiments of the present invention may include the dispenser 100 and the container 10 mounted on the dispenser 100 and accommodating liquid contents.

The dispenser 100 may be configured to discharge an appropriate amount of liquid content to the outside by pressing the container body 11 in a state in which the container 10 is inverted.

The dispenser 100 of the present embodiment may include an outer cap 110 that is fastened to an inlet of the container 10 capable of increasing the internal pressure by an external force and has the nozzle 112 that discharges the contents contained in the container 10, a support portion 120 that has a plurality of support columns 121 provided to be spaced apart from each other around the nozzle 112 inside the outer cap 110, an inertial member 130 that moves toward the nozzle 112 and opens and closes the nozzle 112 when the internal pressure of the container 10 increases, and an elastic member 140 that pushes the inertial member 130 away from the nozzle 112.

The outer cap 110 may be fastened to the inlet of the container 10 when accommodating the support portion 120, the inertial member 130, and the elastic member 140, and may include a second fastening portion 111 and the nozzle 112. The outer cap 110 may be integrally formed with the support portion 120, but is not limited thereto.

The second fastening portion 111 may be provided on an inner peripheral surface of the outer cap 110 and may be fastened to the first fastening portion 12 of the container 10. The second fastening portion 111 may have a screw fastening structure, but is not limited thereto, and may have various fastening structures such as a snap fastening structure.

The nozzle 112 may discharge liquid content to the outside by applying an external force to the container 10 to increase the internal pressure, and may be opened and closed by the inertial member 130.

The nozzle 112 may be provided with the discharge port 1121 that protrudes toward an outside of the container 10 and discharges the liquid content from the nozzle 112 to the outside, and an inlet 1122 that protrudes toward an inside of the container 10 and flows the liquid content contained in the container 10 into the nozzle 112.

The support portion 120 may be provided inside the outer cap 110 to be spaced apart from each other around the nozzle 112, and may include the support column 121, a stopper 122, a first inflow path 123, and a second inflow path 124. The support portion 120 may be integrally formed with the outer cap 110, but is not limited thereto.

The plurality of support columns 121 may be provided to be spaced apart from each other around the nozzle 112 in the outer cap 110. In an embodiment, the case where the support column 121 is provided at each vertex of a rectangle and consists of four columns is described, but it is not limited thereto.

The plurality of support columns 121 may guide the inertial member 130 to move toward the nozzle 112 when the internal pressure of the container 10 increases.

The stopper 122 may be provided at one end of at least one or more of the plurality of support columns 121 facing each other.

The stopper 122 may prevent the inertial member 130 from being detached when the inertial member 130 is separated from the nozzle 112 by the elastic member 140.

The first inflow path 123 may be formed by a space between the plurality of support columns 121 in a discharging direction of the nozzle 112.

The first inflow path 123 may allow the liquid content to pressurize the inertial member 130 when the internal pressure of the container 10 increases.

The second inflow path 124 may be formed by a space between the plurality of support columns 121 in a circumferential direction of the nozzle 112.

The second inflow path 124 may allow liquid content to flow between the inertial member 130 and the nozzle 112 when the inertial member 130 is moved away from the nozzle 112 by the elastic member 140.

In addition, the second inflow path 124 may allow the content to be transferred to the nozzle 112 by a siphon effect when the inertial member 130 moves toward the nozzle 112 when compressing the elastic member 140. The siphon effect will be described later.

When the inner pressure of the inertial member 130 is increased by pressurizing the container 10, the inertial member 130 may be guided by the plurality of support columns 121 while pushing the elastic member 140 and may move toward the nozzle 112 to close the nozzle 112, and when the pressure applied to the container 10 is released, the inertial member 130 may move in an opposite direction to the nozzle 112 by the elastic force of the elastic member 140 to open the nozzle 112.

The inertial member 130 may include a main body portion 131, a guide portion 132, a plug portion 133, and a groove portion 134.

The main body portion 131 may have a cylindrical shape in which one side facing the nozzle 112 is opened and the other side facing the container 10 is closed.

The guide portion 132 may be provided on an outer peripheral surface of the main body portion 131 to correspond to the plurality of support columns 121. In an embodiment, the case where the guide portion 132 extends from one end to the other end of the main body portion 131 is described, but the embodiment is not limited thereto.

The plug portion 133 may have a shape in which the cross section decreases in a direction from an inside of the main body portion 131 toward the nozzle 112 and may have various shapes not being limited thereto.

When the inertial member 130 moves toward the nozzle 112, the plug portion 133 may contact the inlet 1122 of the nozzle 112 to close the nozzle 112.

When the internal pressure of the container 10 is increased, the groove portion 134 is optimized in area so that the pressure received per unit area to which the liquid content contained in the container 10 is pressurized may be maximized, that is, the groove portion 134 may be provided in a concave shape in a direction in which the contained liquid content is pressurized so that the pressure in the container may be effectively received, and may be provided in a shape corresponding to the cross-sectional shape of the plug portion 133 on the other side of the main body portion 131.

The elastic member 140 may be provided between the inertial member 130 and the outer cap 110, and may push the inertial member 130 away from the nozzle 112.

When the inner pressure of the elastic member 140 is increased by pressing the container 10, the elastic member 140 may shrink when the inertial member 130 moves toward the nozzle 112 while being guided by the plurality of support columns 121, and when the pressure applied to the container 10 is released, the elastic member 140 may push away the elastic member 130 from the nozzle 112.

The use state of the dispensing apparatus 1 containing the dispenser 100 and the container 10 according to the first embodiments configured as described above will be described with reference to FIG. 8.

The inertial member 130 may maintain a state in which the elastic member 140 and the stopper 122 are away from the nozzle 112 without pressing the container 10 (refer to FIG. 2), and when the user presses the container 10 after inverting the container 10 to use the liquid content, the liquid content may be discharged to the outside through the nozzle 112 due to the increase in the internal pressure of the container 10, and at the same time, may be pressed by the liquid content flowing through the first inflow path 123 and may move toward the nozzle 112.

In this way, the inertial member 130 may move toward the nozzle 112 that discharges the liquid content due to the increase in the internal pressure of the container 10, and in the process of moving, an end of the main body portion 131 of the inertial member 130 overlaps the inlet 1122 of the nozzle 112, and a pipe line may be formed between the main body portion 131 and the nozzle 112. From this point on, a pipe with a siphon structure may be formed until the plug portion 133 of the inertial member 130 closes the inlet 1122 of the nozzle 112, so that the liquid content is smoothly discharged to the discharge port 1121 of the nozzle 112.

As indicated by the dotted arrow in FIG. 8, the liquid content is discharged from the inside of the container 10 to the outside through the discharge port 1121 of the nozzle 112, and the discharge process will be described through a pipe line.

The pipe line may include a first pipe line formed by the second inflow path 124 of the support portion 120 that delivers liquid content from the inside of the container 10 toward the nozzle 112, a second pipe line formed and connected to the first pipe line by a space between the main body portion 131 of the inertial member 130 and the nozzle 112, and a third pipe line formed and connected to the second pipe line by a space between the plug portion 133 of the main body portion 132 and the inlet 1122 of the nozzle 112, and a fourth pipe line formed by a space between the inlet 1122 and the discharge port 1121 of the nozzle 112 and connected to the third pipe line.

The second to fourth pipe lines may have an inverted shape of ‘U’ and may form a siphon structure in which the length of the second pipe line is short and the length of the fourth pipe line is long. Therefore, when the user presses the container 10, the liquid content may be smoothly discharged to the outside by the siphon principle until the plug portion 133 of the inertial member 130 closes the inlet 1122 of the nozzle 112.

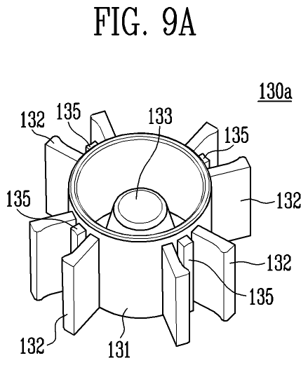

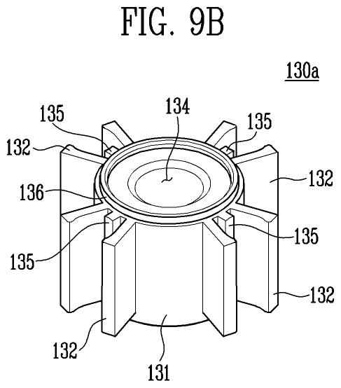

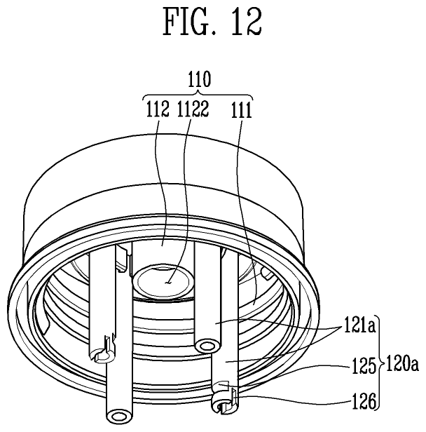

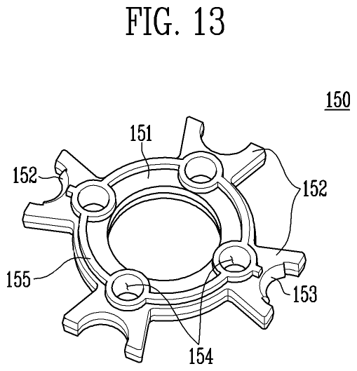

In the dispenser 100 configured as described above, the inertial member 130 and the support portion 120 may be formed in various ways, which will be described below with reference to FIGS. 9 to 13.

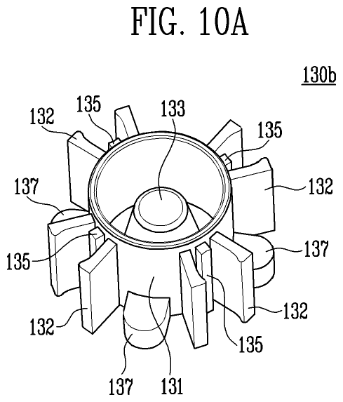

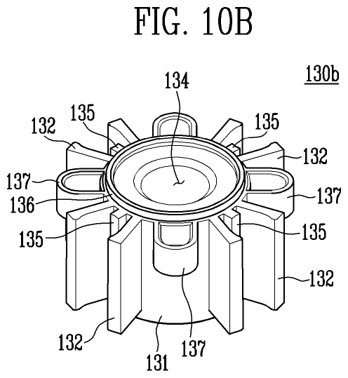

FIGS. 9(a) and 9(b) are perspective views for explaining another embodiment of the inertial member shown in FIG. 7, and FIGS. 10(a) and 10(b) are perspective views for explaining yet another embodiment of the inertial member shown in FIG. 7.

First, referring to FIGS. 9A and 9B, an inertial member 130a according to another embodiment may include the main body portion 131, the guide portion 132, the plug portion 133, the groove portion 134, an auxiliary guide portion 135, and an annular protrusion 136.

The main body portion 131, the guide portion 132, the plug portion 133, and the groove portion 134 are the same as or similar to the above-described configuration of the inertial member 130, and thus description thereof will be omitted here to avoid overlapping description.

The inertial member 130a according to another embodiment is different from the inertial members 130 described above in that the auxiliary guide portion 135 is further provided in the guide portion 132, and the annular protrusion 136 is further provided on an upper surface of the main body portion 131 in a direction of the groove portion 134.

The auxiliary guide portion 135 may have a shape of a rod extending in a longitudinal direction of the support column 121, and may minimize the area for stable ascending and descending in order to reduce the operating friction with the support column 121.

The annular protrusion 136 may protrude to a predetermined width and height on the upper surface of the main body portion 131 in the direction of the groove portion 134.

The annular protrusion 136 may reinforce the bending and rigidity of the main body portion 131 and minimize contact with the other component to reduce frictional force.

Referring to FIGS. 10(a) and 10(b), in an inertial member 130b according to another embodiment, a protrusion 137 may be further provided between adjacent guide portions 132 compared to the inertial member 130a according to the above-described other embodiment.

The protrusion 137 may include a plurality of protrusions to protrude from an outer peripheral surface of the main body portion 131 so that the surface area to which the content accommodated in the container 10 is pressed increases when the internal pressure of the container 10 increases. In an embodiment, the case where the protrusion 137 does not extend from one end to the other end of the main body portion 131 and provided to have a predetermined height only at one end so that the pressing surface area may be expanded is described, but the embodiment is not limited thereto.

In each of the plurality of protrusions 137, a groove may be formed on a side facing the container 10 so as to further increase the internal pressure.

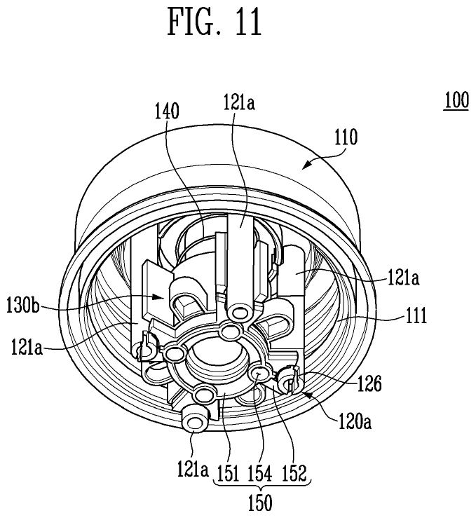

FIGS. 11 and 12 are perspective views for explaining another embodiment of the support portion shown in FIGS. 4 and 6, and FIG. 13 is a perspective view for explaining a stopper applied to the support of another embodiment shown in FIGS. 11 and 12.

Referring to FIGS. 11 and 12, a support portion 120a according to another embodiment may be provided to be spaced apart from each other around the nozzle 112 inside the outer cap 110, and may include a support column 121a, a locking groove 125, and a buffer groove 126. The support portion 120a may be integrally formed with the outer cap 110, but is not limited thereto.

The support column 121a may include a plurality of support columns 121a and the plurality of support columns 121a may be provided to be spaced apart from each other around the nozzle 112 inside the outer cap 110. The plurality of support columns 121a may guide the inertial member 130b according to another embodiment described above to move toward the nozzle 112 when the internal pressure of the container 10 increases.

Although the inertial member 130b according to another embodiment guided by the support column 121a is described, the inertial member 130 described above or the inertial member 130a according to another embodiment may also be applied in the same manner.

In the support portion 120a according to another embodiment, unlike the above-described support portion 120 in which the stopper 122 is provided at an end of the support column 121, the support column 121a is not provided with the stopper 122. Therefore, the inertial member 130b may be detached from the support column 121a, so in order to prevent this, the locking groove 125 and the buffer groove 126 are provided at the end of the support column 121a, and a stopper member 150 to be described later is separately provided.

The locking groove 125 may be concavely provided on at least a portion of an end inner surface of the support column 121a facing each other among the plurality of support columns 121a.

The buffer groove 126 may be formed by cutting the end of the support column 121a provided with the locking groove 125 to a predetermined depth. When the stopper member 150 is pushed between the plurality of support columns 121a, an inner cutout portion of the support column 121a is pushed outward with respect to the buffer groove 126, so that the stopper member 150 may be easily inserted into the locking groove 125.

Although the support portion 120a according to another embodiment is described to be provided with the locking groove 125 and the buffer groove 126 at the end of the support column 121a in order to prevent the inertial member 130b from being detached, a shape similar to the above-described stopper 122 may be realized by using a heat fusion method (using heat to melt a portion of the injection shape) so that the inertial member 130b is not detached even when the stopper member 150 to be described later is not provided.

The stopper member 150 may prevent the inertial member 130b from being separated from the nozzle 112 by the elastic member 140 and may include an annular portion 151, a fixing portion 152, a locking jaw 153, a hole 154, and an annular protrusion 155.

The annular portion 151 may have a ring shape corresponding to the inertial member 130b having a cylindrical shape. The annular portion 151 may be in contact with one end of the inertial member 130b to prevent the inertial member 130b from being detached to the outside.

The fixing portion 152 may include a plurality of fixing portions 152 and may protrude outward from positions corresponding to the plurality of support columns 121a to the outside of the annular portion 151 so that the annular portions 151 may be fixed to the plurality of the support columns 121a.

The locking jaw 153 may be provided to protrude to the outside of the fixing portion 152 and may be inserted into the locking groove 125 at a position corresponding to the support column 121a in which the locking grooves 125 are provided among the plurality of support columns 121a.

The hole 154 may include a plurality of holes 154 and the plurality of holes 154 may be formed by penetrating a portion of the annular portion 151 in which the plurality of fixing portions 152 are located. Since the plurality of the holes 154 are formed by removing the portion of the annular portion 151, the total weight of the stopper member 150 may be reduced. In addition, since the plurality of holes 154 are formed by penetrating, the contents may efficiently pressurize the inertial member 130b when the internal pressure of the container 10 increases.

The annular protrusion 155 may be formed to protrude to a predetermined width and height on the upper surface of the annular portion 151.

The annular protrusion 155 may reinforce the bending and rigidity of the annular portion 151 having a plate shape, and may be firmly assembled to prevent detachment to the outside when assembled to the support portion 120a.

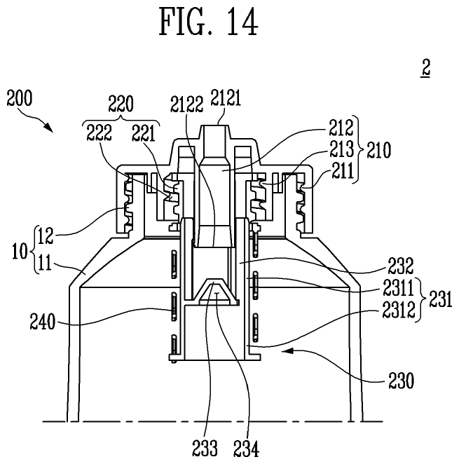

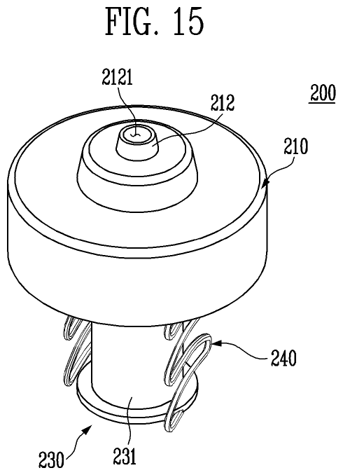

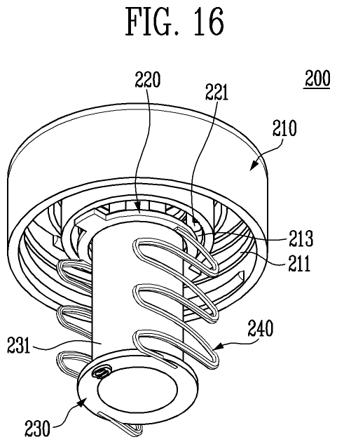

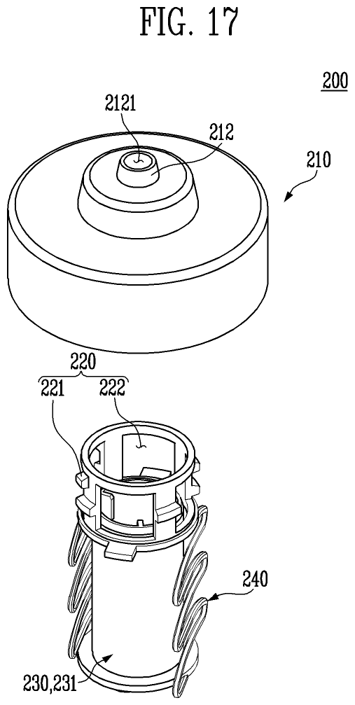

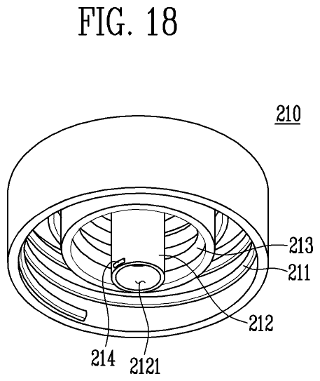

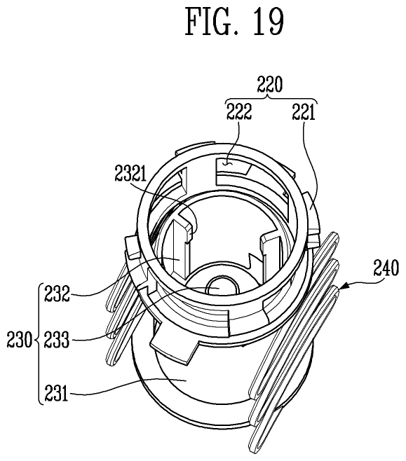

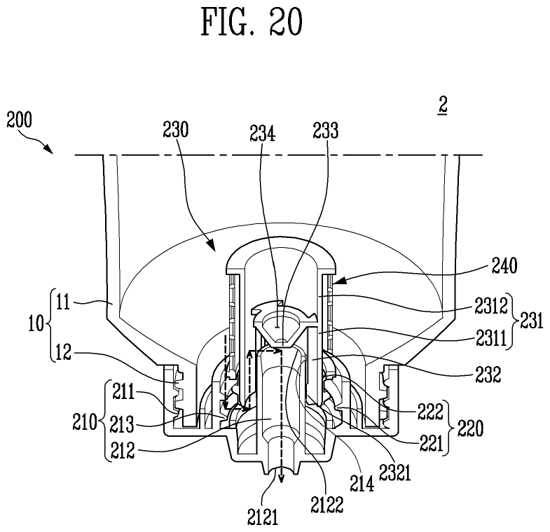

FIG. 14 is a cross-sectional view of a dispensing apparatus containing a dispenser and a container according to second embodiments of the invention, FIG. 15 is a first perspective view of the dispensing apparatus containing the dispenser and the container according to the second embodiments of the invention, FIG. 16 is a second perspective view of the dispenser in the dispensing apparatus containing the dispenser and the container according to the second embodiments of the invention, FIG. 17 is an exploded perspective view of the dispensing apparatus containing the dispenser and the container according to the second embodiments of the present invention, FIG. 18 is a perspective view for explaining an outer cap of the dispenser in the dispensing apparatus containing the dispenser and the container according to the second embodiments of the present invention, FIG. 19 is a perspective view for explaining a support portion, an inertial member, and an elastic member of the dispensing apparatus containing the dispenser and the container according to the second embodiment of the present invention, and FIG. 20 is a diagram for explaining a use state of the dispensing apparatus containing the dispenser the container according to the second embodiments of the present invention.

Referring to FIGS. 14 to 20, a dispensing apparatus 2 according to the second embodiments of the present invention may include a dispenser 200 and the container 10 mounted on the dispenser 200 and accommodating liquid contents.

The dispenser 200 may be configured to discharge an appropriate amount of liquid content to the outside by pressing the container body 11 in a state in which the container 10 is inverted.

The dispenser 200 of the present embodiment may include the outer cap 210 fastened to an inlet of the container 10 capable of increasing the internal pressure by an external force and has a nozzle 212 that discharges the contents contained in the container 10, a support portion 220 provided around the nozzle 212 inside the outer cap 210, an inertial member 230 that moves toward the nozzle 212 in the support portion 220 when the internal pressure of the container 10 increases and opens and closes the nozzle 212, and an elastic member 240 that pushes the inertial members 230 away from the nozzle 212.

The outer cap 210 may be fastened to the inlet of the container 10 while accommodating the support portion 220, the inertial member 230, and the elastic member 240, and may include a second fastening portion 211, the nozzle 212, a third fastening portion 213, and a first protruding portion 214.

The second fastening portion 211 may be provided on an inner peripheral surface of the outer cap 210 and may be fastened to the first fastening portion 12 of the container 10. The second fastening portion 211 may have a screw fastening structure, but is not limited thereto, and may have various fastening structures such as a snap fastening structure.

The nozzle 212 may discharge liquid content to the outside by applying an external force to the container 10 to increase the internal pressure, and may be opened and closed by the inertial member 230.

The nozzle 212 may be provided with the discharge port 2121 that protrudes toward the outside of the container 10 and discharges the liquid content from the nozzle 212 to the outside, and an inlet 2122 that protrudes toward the inside of the container 10, and flows the liquid content contained in the container 10 into the nozzle 212.

The third fastening portion 213 may be provided between the second fastening portion 211 and the nozzle 212, and may be fastened to a fourth fastening portion 221 of the support portion 220. The third fastening portion 213 may allow the support portion 220, the inertial member 230, and the elastic member 240 to be coupled to the outer cap 210 as the third fastening portion 213 is fastened to the fourth fastening portion 221.

The third fastening portion 213 and the fourth fastening portion 221 may have a screw fastening structure, but are not limited thereto, and may have various fastening structures such as a snap fastening structure.

As shown in FIG. 18, the first protruding portion 214 may be provided to protrude outward from the outer peripheral surface of the nozzle 212 toward the discharge port 2121. The first protruding portion 214 is provided to correspond to a second protruding portion 2321 provided in the support portion 220, so that the inertial member 230 may be prevented from sagging when the dispensing apparatus 2 is distributed and stored.

The support portion 220 may be provided to be spaced apart from each other around the nozzle 212 inside the outer cap 210, and may have a cylindrical shape in which one side facing the nozzle 212 and the other side facing the container 10 are opened. The support portion 220 may include the fourth fastening portion 221 and an inflow path 222.

The fourth fastening portion 221 may be provided on the outer peripheral surface of the support portion 220 and may be fastened to the third fastening portion 213 of the outer cap 210. As the fourth fastening portion 221 is fastened to the third fastening portion 213, the support portion 220, the inertial member 230, and the elastic member 240 may be coupled to the outer cap 210.

The inflow path 222 may include a plurality of inflow paths 222 and may be provided by penetrating the outer circumferential surface of the support portion 220 provided with the fourth fastening portion 221 at regular intervals in the circumferential direction of the nozzle 212.

The plurality of inflow paths 222 may allow liquid content to flow into a first portion 2311, which is a portion that partitions a main body portion 231 of the inertial member 230, when the inertial member 230 is moved away from the nozzle 212 by the elastic member 240.

In addition, the plurality of inflow paths 222 may allow contents to be transferred to the nozzle 212 by a siphon effect when the inertial member 230 moves toward the nozzle 212 while compressing the elastic member 240. The siphon effect will be described later.

When the container 10 is pressed to increase the internal pressure, the inertial member 230 may move toward the nozzle 212 inside the support portion 220 while pushing the elastic member 240 to close the nozzle 212, and when the pressure applied to the container 10 is released, the nozzle 212 may be opened by moving in the opposite direction to the nozzle 212 by the elastic force of the elastic member 240.

The inertial member 230 may include the main body portion 231, a guide portion 232, a plug portion 233, and a groove portion 234.

The main body portion 231 may have a cylindrical shape in which one side facing the nozzle 212 and the other side facing the container 10 are opened. For convenience of description, the main body portion 231 is described as being divided into the first portion 2311 facing the nozzle 212 and a second portion 2312 facing the inside of the container 10.

The guide portion 232 may include a plurality of guide portions 232 and the plurality of guide portions 232 may be provided on an inner peripheral surface of the first portion 2311 of the main body portion 231. The plurality of guide portions 232 may extend in the vertical direction at regular intervals on the inner peripheral surface of the first portion 2311 of the main body portion 231, and may correspond to the outer peripheral surface of the nozzle 212 to guide the movement of the main body portion 231 with respect to the nozzle 212.

Thru second protruding portion 2321 corresponding to the first protruding portion 214 may be provided at an end portion of the guide portion 232 to protrude inward as shown in FIG. 19. The second protruding portion 2321 together with the first protruding portion 214 may prevent the inertial member 230 from sagging when the dispensing apparatus 2 is distributed and stored.

The plug portion 233 may be provided in the main body portion 231 between the first portion 2311 and the second portion 2312.

The plug portion 233 may have a shape in which the cross-section decreases from the inside of the main body portion 231 toward the nozzle 212, and may have various shapes not being limited thereto.

When the inertial member 230 moves toward the nozzle 212, the plug portion 233 may contact the inlet 2122 of the nozzle 212 to close the nozzle 212.

The groove portion 234 may have a shape corresponding to a cross-section of the plug portion 233 in the second portion 2312 of the main body portion 231 so as to optimize the area so that the pressure received per unit area to which the liquid content accommodated in the container 10 is pressed may be maximized when the internal pressure of the container 10 increases, that is, to have a concave shape in the direction in which the accommodated liquid content is pressed so that the pressure in the container may be effectively received.

The elastic member 240 may be configured to push the inertial member 230 away from the nozzle 212.

The support portion 220, the inertial member 230, and the elastic member 240 of the present embodiment may be integrally formed of one material. The elastic member 240 is provided on the outer periphery of the inertial member 230, one end of which is connected to the support portion 220, the other end of which is connectable to the inertial member 230, and the elastic member 240 may become integral with the support portion 220 and the inertial member 230.

When the inner pressure of the elastic member 240 is increased by pressing the container 10, the elastic member 240 shrinks when the inertial member 230 moves toward the nozzle 212 while being guided by the guide portion 232, and when the pressure applied to the container 10 is released, the inertial member 230 may be pushed in a direction away from the nozzle 212.

The use state of the dispensing apparatus 2 containing the dispenser 200 and the container 10 according to the second embodiments configured as described above will be described with reference to FIG. 20.

The inertial member 230 may maintain a state away from the nozzle 212 by the support portion 220 and the elastic member 240 without pressing the container 10 (refer to FIG. 14), and when the user presses the container 10 after inverting to use the liquid content, the liquid content may be discharged to the outside through the nozzle 212 due to an increase in the internal pressure of the container 10, may be pressed, and may move toward the nozzle 212.

The inertial member 230 may move toward the nozzle 212 that discharges the liquid content due to the increase in the internal pressure of the container 10, and in the process of moving, the end of the main body portion 231 of the inertial member 230 overlaps the inlet 2122 of the nozzle 212, and a pipe line may be formed between the main body portion 231 and the nozzle 212. From this point on, a pipe with a siphon structure is formed until the plug portion 233 of the inertial member 230 closes the inlet 2122 of the nozzle 212, so that the liquid content may be smoothly discharged to the discharge port 2121 of the nozzle 212.

The liquid content may be discharged from the inside of the container 10 to the outside through the discharge port 2121 of the nozzle 212, as indicated by the dotted arrow in FIG. 20, and the discharge process will be explained through a pipe line.

The pipe line may include a first pipe line formed by the inflow path 222 of the support portion 220 that delivers the liquid content from the inside of the container 10 toward the nozzle 212, a second pipe line that is formed by a space between the main body portion 231 of the inertial member 230 and the nozzle 212 and that is connected to the first pipe line, a third pipe line that is formed by a space between the plug portion 233 of the main body portion 231 and the inlet 2122 of the nozzle 212 and that is connected to the second pipe line, and a fourth pipe line that is formed by a space between the inlet 212 and the discharge port 2121 of the nozzle 212 and that is connected to the third pipe line.

The second to fourth pipe lines may have an inverted shape of ‘U’ and form a siphon structure in which the length of the second pipe line is short and the length of the fourth pipe line is long. Therefore, when the user presses the container 10, the liquid content may be smoothly discharged to the outside by the siphon principle until the plug portion 233 of the inertial member 230 closes the inlet 2122 of the nozzle 212.

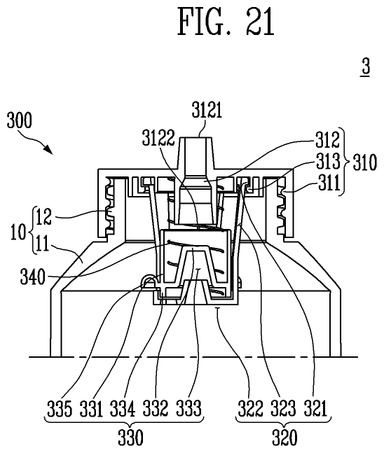

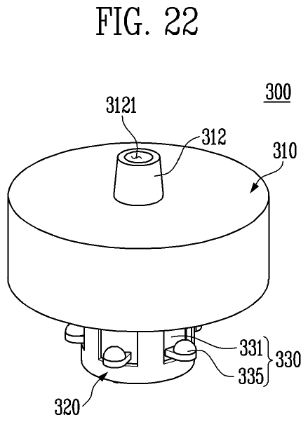

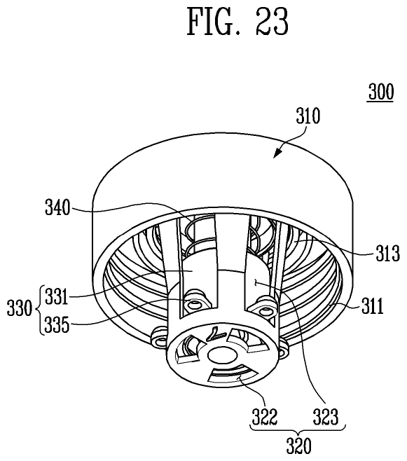

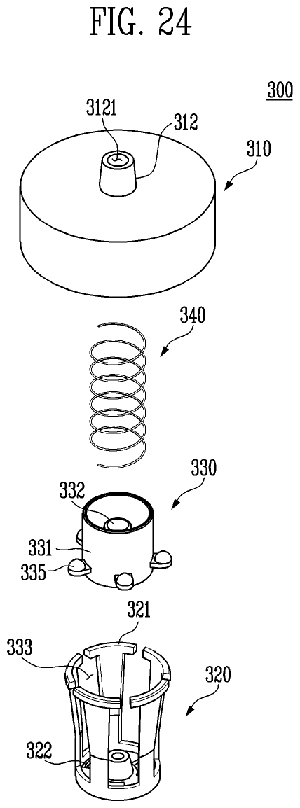

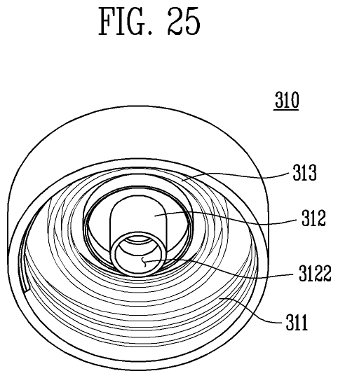

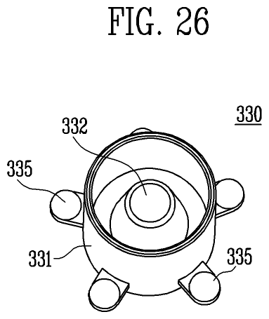

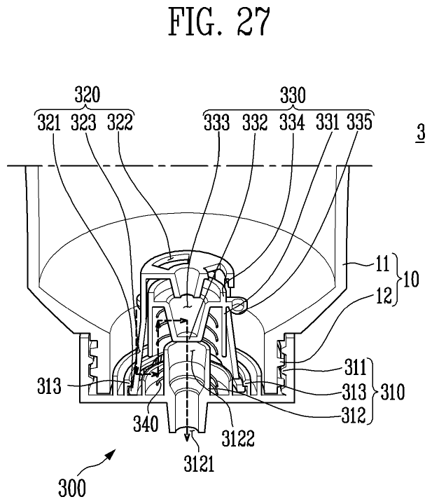

FIG. 21 is a cross-sectional view of a dispensing apparatus containing a dispenser and a container according to third embodiments of the present invention, FIG. 22 is a first perspective view of the dispensing apparatus containing the dispenser and the container according to the third embodiments of the invention, FIG. 23 is a second perspective view of the dispenser, in the dispensing apparatus containing the dispenser and the container according to the third embodiments of the invention, FIG. 24 is an exploded perspective view of the dispensing apparatus containing the dispenser and the container according to the third embodiments of the present invention, FIG. 25 is a perspective view for explaining an outer cap of the dispenser in the dispensing apparatus containing the dispenser and the container according to the third embodiments of the present invention. FIG. 26 is a perspective view for explaining an inertial member of the dispenser in the dispensing apparatus containing the dispenser and the container according to the third embodiments of the present invention, and FIG. 27 is a diagram for explaining a use state of the dispensing apparatus containing the dispenser and the container according to the third embodiments of the present invention.

Referring to FIGS. 21 to 27, a dispensing apparatus 3 according to the third embodiments of the present invention may include a dispenser 300 and the container 10 mounted on the dispenser 300 and accommodating liquid contents.

The dispenser 300 may be configured to discharge an appropriate amount of liquid content to the outside by pressing the container body 11 in a state in which the container 10 is inverted.

The dispenser 300 of the present embodiment may include the outer cap 310 that is fastened to the inlet of the container 10 capable of increasing the internal pressure by an external force and has a nozzle 312 for discharging the contents contained in the container 10, a housing 320 provided around the nozzle 312 inside the outer cap 310, an inertial member 330 that moves toward the nozzle 312 in the housing 320 and opens and closes the nozzle 312 when the internal pressure of the container 10 increases, and an elastic member 340 that pushes the inertial members 330 away from the nozzle 312.

The outer cap 310 may be fastened to the inlet of the container 10 while accommodating the housing 320, the inertial member 330, and the elastic member 340, and may include a second fastening portion 311, the nozzle 312, and a third fastening portion 313.

The second fastening portion 311 may be provided on an inner peripheral surface of the outer cap 310, and may be fastened to the first fastening portion 12 of the container 10. The second fastening portion 311 may be a screw fastening structure, but is not limited thereto, and may have various fastening structures such as a snap fastening structure.

The nozzle 312 may discharge liquid content to the outside by applying an external force to the container 10 to increase the internal pressure, and may be opened and closed by the inertial member 330.

The nozzle 312 may include the discharge port 3121 that protrudes toward the outside of the container 10 and discharges the liquid content from the nozzle 312 to the outside, and an inlet 3122 that protrudes toward the inside of the container 10, and flows the liquid content contained in the container 10 into the nozzle 312.

The third fastening portion 313 may be provided between the second fastening portion 311 and the nozzle 312 to be fastened to a fourth fastening portion 321 of the housing 320. The third fastening portion 313 may allow the housing 320, the inertial member 330, and the elastic member 340 to be coupled to the outer cap 310 as it is fastened to the fourth fastening portion 321.

The third fastening portion 313 and the fourth fastening portion 321 may have an undercut fastening structure, but are not limited thereto, and may have various fastening structures such as a screw fastening structure or a snap fastening structure.

The housing 320 may be provided to be spaced apart from each other around the nozzle 312 inside the outer cap 310, and may have a cylindrical shape in which one side facing the nozzle 312 is opened and the other side facing the container 10 is partially opened. The housing 320 may include the fourth fastening portion 321, a first inflow path 322, and a second inflow path 323.

The fourth fastening portion 321 may be provided at the end of the outer circumferential surface of the housing 320, and may be fastened to the third fastening portion 313 of the outer cap 310. The fourth fastening portion 321 may allow the housing 320, the inertial member 330, and the elastic member 340 to be coupled to the outer cap 310 as it is fastened to the third fastening portion 313.

The first inflow path 322 may include a plurality of first inflow paths 322 and the plurality of first inflow paths 322 may be provided in a partially open portion on the other side of the housing 320 opposite to the nozzle 312 with respect to the inertial member 330.

The plurality of first inflow paths 322 may allow liquid content to flow from the outside to the inside of the housing 320 by increasing the internal pressure of the container 10, so that the liquid content may pressurize the inertial member 330.

The second inflow path 323 may be provided on a side surface of the housing 320 facing the nozzle 312 with respect to the inertial member 330. The second inflow path 323 may include a plurality of second inflow paths 323 and the plurality of second inflow paths 323 may be provided by cutting the outer circumferential surface of the housing 320 at regular intervals in the circumferential direction of the nozzle 312.

The plurality of second inflow paths 323 may allow liquid content to flow into the housing 320 when the inertial member 330 is moved away from the nozzle 312 by the elastic member 340.

In addition, the second inflow path 323 may allow the content to be transferred to the nozzle 312 by the siphon effect when the inertial member 330 moves toward the nozzle 312 while compressing the elastic member 340. The siphon effect will be described later.

When the inner pressure of the inertial member 330 is increased by pressing the container 10, the inertial member 330 may move toward the nozzle 312 inside the housing 320 while pushing the elastic member 340 to close the nozzle 312, and when the pressure applied to the container 10 is released, the inertial member 330 may move in the opposite direction to the nozzle 312 by the elastic force of the elastic member 340 and open the nozzle 312.

The inertial member 330 may include a main body portion 331, a plug portion 332, a groove portion 333, a rib 334, and a protrusion 335.

The main body portion 331 may have a cylindrical shape in which one side facing the nozzle 312 is opened and the other side facing the container 10 is closed.

The plug portion 332 may have a shape in which the cross section decreases in a direction toward the nozzle 312 from the inside of the main body portion 331, and may have various shapes without being limited thereto.

When the inertial member 330 moves toward the nozzle 312, the plug portion 332 may contact the inlet 3122 of the nozzle 312 to close the nozzle 312.

The groove portion 333 may have a concave shape in a direction in which the contained liquid content is pressurized so that the area may be optimized and the pressure received per unit area pressurized by the liquid content contained in the container 10 may be maximized when the internal pressure of the container 10 rises, that is, the groove portion 333 may be provided in a shape corresponding to the cross-sectional shape of the plug portion 332 on the other side of the main body portion 331 so that the pressure in the container may be effectively received.

The rib 334 may be provided to extend a predetermined length toward the container 10 along the edge of the other side of the main body portion 331 so as to minimize friction when moving up and down inside the housing 320.

This rib 334 may guide the movement of the body portion 331 relative to the housing 320.

The protrusion 335 may include a plurality of protrusions 335 and may b protrude from the outer peripheral surface of the main body portion 331 so that the surface area to which the contents accommodated in the container 10 are pressed increases when the internal pressure of the container 10 increases.

Each of the plurality of protrusions 335 may be inserted into the second inflow path 323 of the housing 320, and may be moved along the second inflow path 323 when the inertial member 330 moves up and down. The plurality of protrusions 335 may have a hemispherical shape with grooves on the side facing the container 10.

The elastic member 340 may be provided between the inertial member 330 and the outer cap 310, and may push the inertial member 330 away from the nozzle 312.

When the inner pressure of the elastic member 340 is increased by pressing the container 10, the elastic member 340 contracts when the inertial member 330 moves toward the nozzle 312 while being guided in the housing 320, and when the pressure applied to the container 10 is released, the elastic member 330 may be pushed in a direction away from the nozzle 312.

The use state of the dispensing apparatus 3 containing the dispenser 300 and the container 10 according to the third embodiment configured as described above will be described with reference to FIG. 27.

The inertial member 330 may maintain a state away from the nozzle 312 by the housing 320 and the elastic member 340 without pressing the container 10 (refer to FIG. 21), and when the user presses the container 10 after inverting the container 10 to use the liquid content, the liquid content may be discharged to the outside through the nozzle 312 due to an increase in the internal pressure of the container 10, and at the same time, may be pressed by the liquid content flowing through the first inflow path 322 and may move toward the nozzle 312.

The inertial member 330 may move toward the nozzle 312 that discharges the liquid content due to the increase in the internal pressure of the container 10, and in the process of moving, the end of the main body portion 331 of the inertial member 330 may overlap the inlet 3122 of the nozzle 312, and a pipe line may be formed between the main body 331 and the nozzle 312. From this point on, a pipe with a siphon structure may be formed until the plug portion 332 of the inertial member 330 closes the inlet 3122 of the nozzle 312, so that the liquid content may be smoothly discharged to the discharge port 3121 of the nozzle 312.

The liquid content may be discharged from the inside of the container 10 to the outside through the discharge port 3121 of the nozzle 312, as indicated by the dotted arrow in FIG. 27, and the discharge process will be explained through a pipe line.

The pipe line may include a first pipe line formed by the second inflow path 323 of the housing 320 that delivers liquid content from the inside of the container 10 in the direction of the nozzle 312, a second pipe line formed and connected to the first pipe line by a space between the main body portion 331 of the inertial member 330 and the nozzle 312, and a third pipe line formed and connected to the second pipe line by a space between the plug portion 332 of the main body portion331 and the inlet 312 of the nozzle 312, and a fourth pipe line formed of a space between the inlet 3122 of the nozzle 312 and the discharge port 3121 and connected to the third pipe line.

The second to fourth pipe lines may have an inverted shape of ‘U’ and form a siphon structure in which the length of the second pipe line is short and the length of the fourth pipe line is long. Therefore, when the user presses the container 10, the liquid content may be smoothly discharged to the outside by the siphon principle until the plug portion 332 of the inertial member 330 closes the inlet 3122 of the nozzle 312.

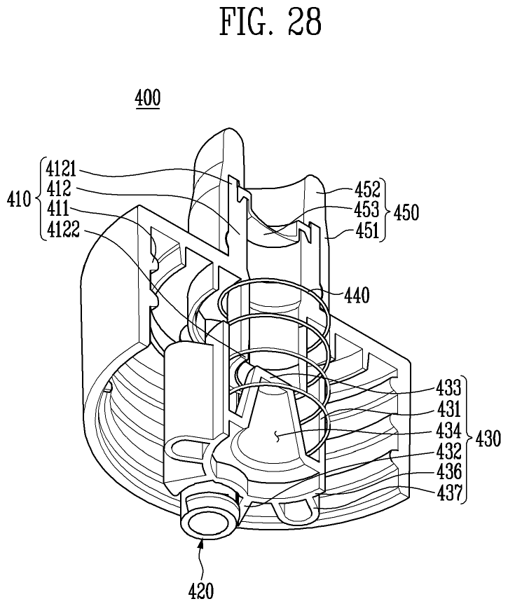

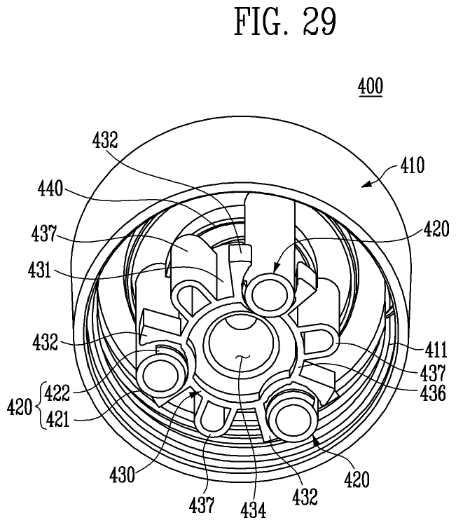

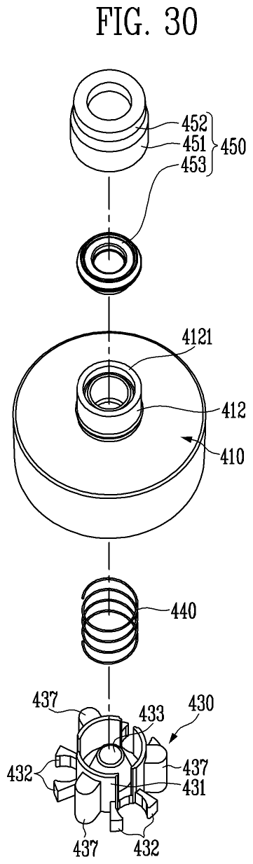

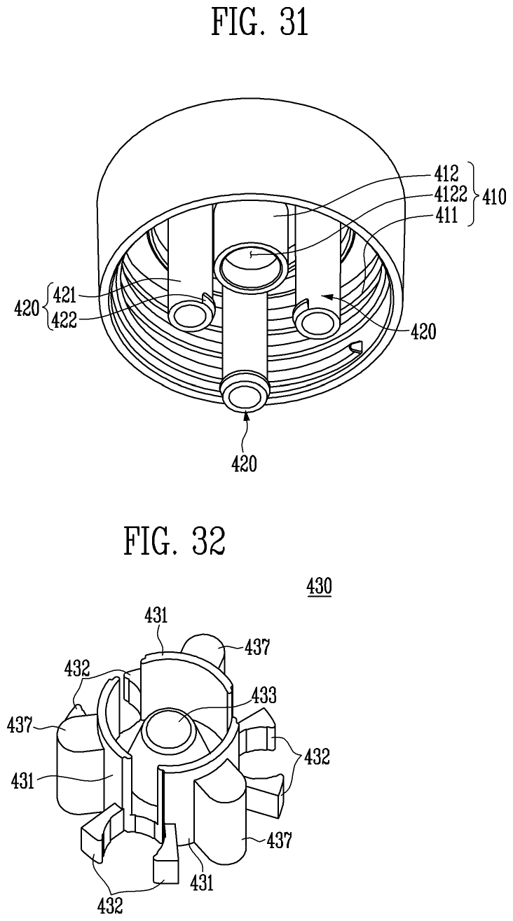

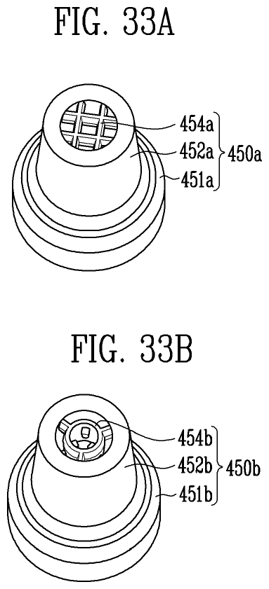

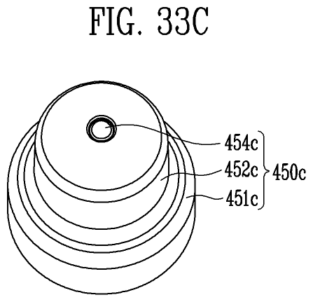

FIG. 28 is a cross-sectional perspective view of a dispensing apparatus containing a dispenser and a container according to fourth embodiments of the present invention, FIG. 29 is a perspective view of the dispensing apparatus containing the dispenser and the container according to the fourth embodiments of the present invention, FIG. 30 is an exploded perspective view of the dispensing apparatus containing the dispenser and the container according to the fourth embodiments of the present invention, FIG. 31 is a perspective view for explaining an outer cap and a support portion of the dispenser in the dispensing apparatus containing the dispenser and the container according to the fourth embodiments of the present invention, FIG. 32 is a perspective view for explaining an inertial member of the dispenser in the dispensing apparatus containing the dispenser and the container according to the fourth embodiments of the present invention, and FIGS. 33(a), 33(b), and 33(c) are views for explaining various embodiments of a discharge member of FIG. 30.

Referring to FIGS. 1(a) and 1(b) and FIGS. 28 to 33, a dispensing apparatus 4 according to the fourth embodiments of the present invention may include a dispenser 400 and the container 10 mounted on the dispenser 400 and accommodating liquid contents.

The dispenser 400 may be configured to discharge an appropriate amount of liquid content to the outside by pressing the container body 11 in a state in which the container 10 is inverted.

The dispenser 400 of the present embodiment may include an outer cap 410 having a nozzle 412 that is fastened to the inlet of the container 10 capable of increasing the internal pressure by an external force and discharges the contents contained in the container 10, a support portion 420 having a plurality of support columns 421 that are provided to be spaced apart from each other around the nozzle 412 inside the outer cap 410, an inertial member 430 that moves toward the nozzle 412 and opens and closes the nozzle 412 when the internal pressure of the container 10 increases, an elastic member 440 that pushes the inertial member 430 away from the nozzle 412, and the discharge member 450 that is provided in consideration of the viscosity, discharge sensitivity, and usage of the contents and is coupled to the nozzle 412.

The outer cap 410 may be fastened to the inlet of the container 10 while accommodating the support portion 420, the inertial member 430, and the elastic member 440, and may include a second fastening portion 411 and the nozzle 412. The outer cap 410 may be integrally formed with the support 120, but is not limited thereto.

The second fastening portion 411 may be provided on an inner peripheral surface of the outer cap 410, and may be fastened to the first fastening portion 12 of the container 10. The second fastening portion 411 may have a screw fastening structure, but is not limited thereto, and may have various fastening structures such as a snap fastening structure.

The nozzle 412 may discharge liquid content to the outside by applying an external force to the container 10 to increase the internal pressure, and may be opened and closed by the inertial member 430.

The nozzle 412 may be provided with the discharge port 4121 that protrudes toward the outside of the container 10 and discharges the liquid content from the nozzle 412 to the outside, and an inlet 4122 that protrudes toward the inside of the container 10, and flows the liquid content contained in the container 10 into the nozzle 412.

In this embodiment, unlike the first embodiments described above, the discharge member 450 may be coupled to the nozzle 412, and when the discharge member 450 is coupled, the contents may be discharged to the outside through the discharge member 450 via the nozzle 412.

The support portion 420 may be provided to be spaced apart from each other around the nozzle 412 inside the outer cap 410, and may include a support column 421 and a stopper 422. The support portion 420 may be integrally formed with the outer cap 410, but is not limited thereto.

The support column 421 may include a plurality of support columns 421 and may be provided to be spaced apart from each other around the nozzle 412 inside the outer cap 410.

The plurality of support columns 121 may guide the inertial member 430 to move toward the nozzle 112 when the internal pressure of the container 10 increases.

Unlike the four support columns 121 of the first embodiments described above, the support columns 421 of the present embodiment may be formed of three by providing one at each vertex of a triangle.

By reducing the number of the support columns 421 in the present embodiment to three, the friction during the vertical movement of the inertial member 430 may be relatively reduced compared to the case where the support columns 421 are provided in the number of four or more, thereby improving user satisfaction.

The stopper 422 may be provided toward the inertial member 430 at an end of each of the plurality of support columns 421.

The stopper 422 may prevent the inertial member 430 from being detached when the inertial member 430 is separated from the nozzle 412 by the elastic member 440.

The support portion 420 may have an inflow path formed therein so as to discharge contents as the inertial member 430 moves up and down while supporting the inertial member 430. Although the inflow path is not shown in this embodiment, the inflow path of this embodiment may be the same as the first inflow path 123 and the second inflow path 124 of the first embodiments, and thus a detailed description thereof will be omitted here. However, the first inflow path 123 and the second inflow path 124 of the first embodiments are formed when there are four support columns 121, and the inflow path of the present embodiment is formed when there are three support columns 421, so there may be differences in terms of the path, but the principle of transferring the contents to the nozzle 412 by the siphon effect is the same as in the first embodiments.

When the inner pressure of the inertial member 430 is increased by pressurizing the container 10, the inertial member 430 may be guided by the plurality of support columns 421 while pushing the elastic member 440 and moves toward the nozzle 412 to close the nozzle 412, and when the pressure applied to the container 10 is released, the nozzle 412 may be opened by moving in the opposite direction to the nozzle 412 by the elastic force of the elastic member 440.

The inertial member 430 may include a main body portion 431, a guide portion 432, a plug portion 433, a groove portion 434, an annular protrusion 436, and a protrusion 437.

The main body portion 431 has a cylindrical shape in which one side facing the nozzle 412 is opened and the other side facing the container 10 is closed, and a portion corresponding to the support column 421 of the support portion 420 may have a cylindrical shape with an incision.

That is, the main body portion 431 of the present embodiment may have a discontinuous cylindrical shape in which a portion where the three support columns 421 are in contact is opened, and a portion between the three support columns 421 is closed.

The main body portion 431 may be formed in a discontinuous cylindrical shape in which a portion corresponding to the support column 421 is opened in order to minimize friction with the main body portion 430 when the inertial member 430 moves up and down.

The guide portion 432 may be provided on the outer peripheral surface of the main body portion 431 to correspond to the plurality of support columns 421.

In this embodiment, the guide portion 432 may not extend from one end of the main body portion 431 to the other end, but is provided only at the edge of the other closed portion of the main body portion 431 so that friction with the support column 421 may be minimized when the inertial member 430 moves up and down.

The plug portion 433 may have a shape in which the cross section decreases in the direction from the inside of the main body portion 431 toward the nozzle 412, and may have various shapes not being limited thereto.

When the inertial member 430 moves toward the nozzle 412, the plug portion 433 may contact the inlet 4122 of the nozzle 412 to close the nozzle 412.

The discharge amount of the content may be adjusted according to the distance between the plug portion 433 and the nozzle 412.

For example, when the position of the nozzle 412 is fixed, the longer the length of the plug portion 433 is, the shorter the stroke distance of the inertial member 430 is, and the discharge amount of the contents may be reduced. As the length of the stopper plug portion 433 increases, the length of the inertial member 430 may also be increased. That is, the distance between the plug portion 433 and the nozzle 412 may be adjusted according to the length of the plug portion 433. The distance between the plug portion 433 and the nozzle 412 may be adjusted according to the lengths of the plurality of support columns 421.

In this embodiment, the length of the plug portion 433 that is longer than that of the plug portion 533 of the fifth embodiment to be described later (refer to FIGS. 33 and 38) is illustrated, as in this embodiment, the inertial member 430 with a longer length of the plug portion 433 is suitable for use when the contents are low viscosity (e.g., 1 cps to 70 cps) and the required discharge capacity is small (e.g., 0.5 cc to 1 cc), such as a foot shampoo scrub (viscosity of 30 cps or less) or a doctor grute ampoule treatment (viscosities of 30 cps and more).

The groove portion 434 may have a concave shape in the direction in which the contained liquid content is pressurized so that the area may be optimized so that the pressure received per unit area pressurized by the liquid content contained in the container 10 may be maximized when the internal pressure of the container 10 increases, so that the pressure in the container may be effectively received, and may have a shape corresponding to the cross-sectional shape of the plug portion 433 on the other side of the main body portion 431.

The annular protrusion 436 may be formed to protrude to a predetermined width and height on the upper surface of the main body portion 431 in the direction of the groove portion 434.

The annular protrusion 436 may reinforce the bending and rigidity of the main body portion 431 and minimize contact with the other component to reduce frictional force.

The protrusion 437 may be provided in the main body portion 431 between adjacent guide portions 432.

The protrusion 437 may include a plurality of protrusions 437 and may protrude from the outer peripheral surface of the main body portion 431 so that the surface area to which the contents accommodated in the container 10 are pressed increases when the internal pressure of the container 10 increases.

In each of the plurality of protrusions 437, a groove may be formed on the side facing the container 10 so as to further increase the internal pressure.

Unlike the protrusion 137 of the first embodiments described above, the protrusion 437 of the present embodiment may be provided to extend from one end to the other end of the main body portion 431.

In the case of the first embodiments, the main body portion 131 has a continuous cylindrical shape and may maintain an appropriate strength by itself, but in this embodiment, since the main body portion 431 is formed in a discontinuous cylindrical shape as described above, the strength is inevitably weaker than that of the main body portion 131 of the first embodiments and therefore, the protrusions 437 may be extended in this way to compensate for the vulnerability of such strength.

The elastic member 440 may be provided between the inertial member 430 and the outer cap 410, and may push the inertial member 430 away from the nozzle 412. The elastic member 440 may be a spring, but is not limited thereto.

The elastic member 440 may shrink when the inertial member 430 moves toward the nozzle 412 while being guided by the plurality of support columns 421 when the internal pressure is raised by pressing the container 10, and when the pressure applied to the container 10 is released, the inertial member 430 may be pushed away from the nozzle 412.

The elastic member 440 may adjust the discharge amount of the content together with the plug portion 433. In other words, the longer the stroke distance of the inertial member 430 is, the longer the elastic member 440 may be formed, and conversely, the shorter the stroke distance is, the shorter the elastic member 440 may be formed in proportion thereto.

The discharge member 450 may be coupled to the nozzle 412 and may discharge the contents passing through the nozzle 412 to the outside.

The discharge member 450 may include a coupling portion 451 coupled to the nozzle 412, a discharge portion 452 extending outward from the coupling portion 451 by a predetermined length to discharge the contents to the outside, and a valve portion 453 opened when the container 10 is pressed and closed when the pressing is released.

The coupling portion 451 and the discharge portion 452 may be integral, and may have a path through which the contents flowing out from the nozzle 412 move.

The coupling portion 451 may be coupled to the nozzle 412 by a clamping coupling method or a bolting coupling method.

That is, the coupling portion 451 has an inner diameter corresponding to the outer diameter of the nozzle 412.

The discharge portion 452 may extend from the coupling portion 451, but the outer diameter may be the same as the outer diameter of the coupling portion 451 or may become smaller toward the outlet side, and the inner diameter may be smaller than the inner diameter of the coupling portions 451 and may extend the same as the inner diameter of a nozzle 412 or may become smaller towards the outlet side.

That is, the discharge portion 452 may have a cylindrical shape as a whole or a tapered shape whose width gradually decreases toward the outlet side. The larger the taper amount of the discharge portion 452, the smaller the size of the outlet may become. The outlet of the discharge part 452 may be basically circular.

The inner diameter of the discharge portion 452 is smaller than the inner diameter of the coupling portion 451, so a step (not shown in the figure) may be formed in the inner diameter.

The valve portion 453 is installed at the upper end of the discharge port 4121 of the nozzle 412 so as to open and close the discharge port 4121, but when the coupling portion 451 is coupled to the nozzle 421, the valve portion 453 may be fixedly installed by being pressed against a step formed at an inner boundary between the coupling portion 451 and the discharge port 452.

The valve portion 453 may include a silicon valve. The silicone valve may increase the discharge sensitivity when applied to the inertial member 430 in which the content is low in viscosity and a small amount is discharged, for example, the inertial member 430 with the plug portion 433 of longer length as described above.

The discharge member 450 configured as described above may be implemented in various ways according to the viscosity and discharge amount of the contents, and various embodiments of the discharge member 450 will be described with reference to FIGS. 33(a), 33(b), and 33(c).

Discharge member 450a of an embodiment illustrated in FIG. 33(a) may include a coupling portion 451a and a discharge portion 452a having the same or similar structure as the coupling portion 451 and the discharge portion 452 of the discharge member 450 described above.

In addition, the discharge member 450a of an embodiment may further include a discharge means 454a provided at an outlet of the discharge portion 452a.

The discharge means 454a may have a lattice shape.

As such, the discharge member 450a of an embodiment in which the discharge means 454a has a lattice shape may be suitable when the contents are low-viscosity, such as the foot shampoo scrub (viscosity of 30 cps or less) described above, and the method of use is a dispersion method.

Discharge member 450b of another embodiment illustrated in FIG. 33(b) may include a coupling portion 451b and a discharge portion 452b having the same or similar structure as the coupling portion 451 and the discharge portion 452 of the discharge member 450 described above.

In addition, the discharge member 450b of another embodiment may further include a discharge means 454b at an outlet of the discharge part 452b.

The discharge means 454b may have a deformed lattice shape with a central cylinder and a diaphragm formed at regular intervals from the cylinder.

The discharge member 450b of another embodiment in which the discharge means 454b is a deformed lattice shape is suitable when the contents are low-viscosity and the use method is a dispersion method, such as the foot shampoo scrub (viscosity of 30 cps or less) described above.

Discharge member 450c of another embodiment illustrated in FIG. 33C may include a coupling portion 451c and a discharge portion 452c having the same or similar structure as the coupling portion 451 and the discharge portion 452 of the discharge member 450 described above.

In addition, the discharge member 450c of another embodiment may further include a discharge means 454c at an outlet of the discharge portion 452c.

The discharge means 454c may be provided inside the integrally formed coupling portion 451c and the discharge portion 452c, and may be of an on/off type in which the outlet is opened and closed by holding the coupling portion 451b or the discharge portion 452c and rotating left and right.

The discharge member 450c of another embodiment in which the discharge means 454b is turned on/off is suitable when the contents are low-viscosity, such as the above-described doctor grute ampoule treatment (viscosity of 30 cps or more), and the method of use is not a dispersion method.

The discharge members 450a, 450b, and 450c of the above embodiments may include the valve portion 453 that is the same as or similar to the discharge member 450.

The use state of the dispensing apparatus 4 containing the dispenser 400 and the container 10 according to the fourth embodiment configured as described above is the same as or similar to that described with reference to FIG. 8 in the first embodiments described above, so the description will be omitted here.

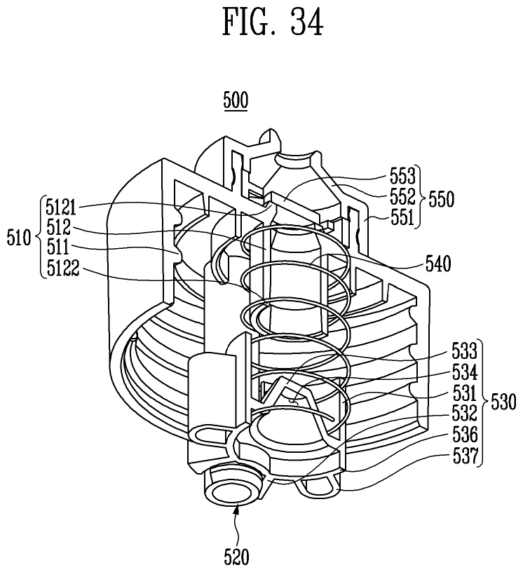

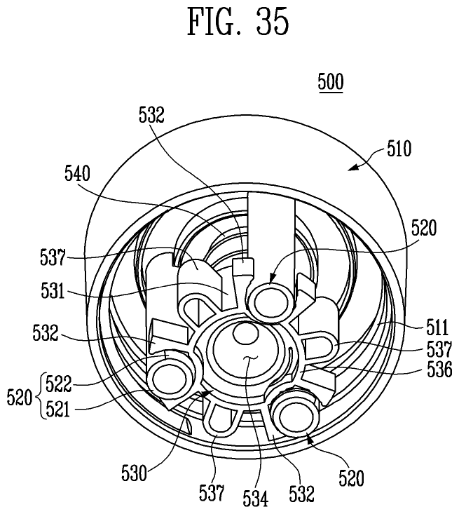

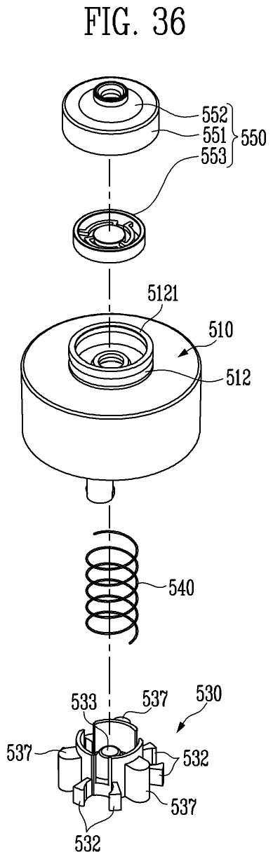

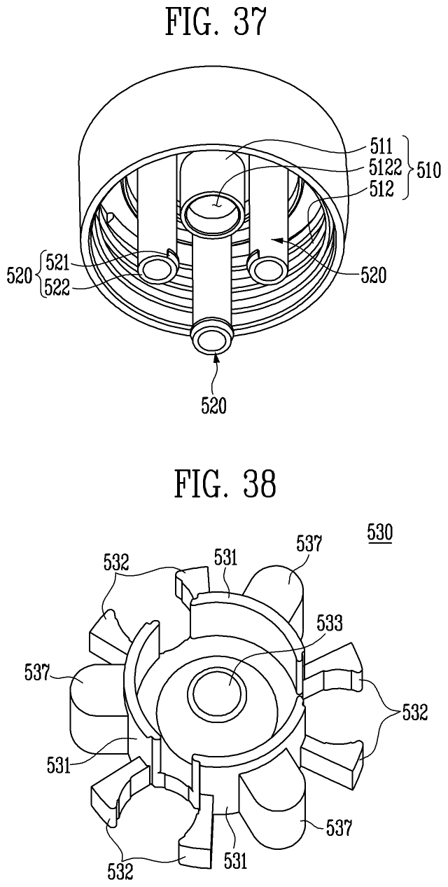

FIG. 34 is a cross-sectional perspective view of a dispensing apparatus containing a dispenser and a container according to fifth embodiments of the present invention, FIG. 35 is a perspective view of the dispensing apparatus containing the dispenser and the container according to the fifth embodiments of the present invention, FIG. 36 is an exploded perspective view of the dispensing apparatus containing the dispenser and the container according to the fifth embodiments of the present invention, FIG. 37 is a perspective view for explaining an outer cap and a support portion of the dispenser in the dispensing apparatus containing the dispenser and the container according to the fifth embodiments of the present invention, and FIG. 38 is a perspective view for explaining an inertial member of the dispensing apparatus containing the dispenser and the container according to the fifth embodiments of the present invention.

Referring to FIGS. 1(a) and 1(b) and FIGS. 34 to 38, a dispensing apparatus 5 according to the fifth embodiments of the present invention may include a dispenser 500 and the container 10 mounted on the dispenser 500 and accommodating liquid contents.

The dispenser 500 may be configured to discharge an appropriate amount of liquid content to the outside by pressing the container body 11 in a state in which the container 10 is inverted.

The dispenser 500 of the present embodiment may include an outer cap 510 having the nozzle 512 that is fastened to the inlet of the container 10 capable of increasing the internal pressure by an external force and discharges the contents contained in the container 10, a support portion 520 having a plurality of support columns 521 that are provided to be spaced apart from each other around the nozzle 512 inside the outer cap 510, an inertial member 530 that is guided by the plurality of support column 521 and moves toward the nozzle 512 to open and close the nozzle 512 when the internal pressure of the container 10 increases, an elastic member 540 that pushes the inertial members 530 away from the nozzle 512, and the discharge member 550 that is provided in consideration of the viscosity, discharge sensitivity, and usage of the contents and is coupled to the nozzle 512.

The outer cap 510 may be fastened to the inlet of the container 10 while accommodating the support portion 520, the inertial member 530, and the elastic member 540, and may include a second fastening portion 511 and the nozzle 512. The outer cap 510 may be integrally formed with the support portion 520, but is not limited thereto.

The second fastening portion 511 may be provided on an inner peripheral surface of the outer cap 510, and may be fastened to the first fastening portion 12 of the container 10. The second fastening portion 511 may have a screw fastening structure, but is not limited thereto, and may have various fastening structures such as a snap fastening structure.

The nozzle 512 may discharge liquid content to the outside by applying an external force to the container 10 to increase the internal pressure, and may be opened and closed by the inertial member 530.

The nozzle 512 may be provided with the discharge port 5121 which protrudes toward the outside of the container 10 and discharges liquid contents from the nozzle 512 to the outside, and an inlet 5122 which protrudes toward the inside of the container 10, and flows liquid contents contained in the container 10 into the nozzle 512.

In this embodiment, the discharge member 550 may be coupled to the nozzle 512 as in the fourth embodiments, and when the discharge member 550 is coupled, the contents may be discharged to the outside through the discharge member 550 via the nozzle 512.

In addition, as will be described later, the nozzle 512 of the present embodiment may have a size in which the diameter of the portion extending outward of the outer cap 510 may accommodate the disk valve, unlike the nozzle 412 of the fourth embodiments, by applying the disk valve to a valve portion 553 of the discharge member 550.

That is, when the nozzle 512 of the present embodiment has a structure in which the diameter of the portion extending to the inside of the outer cap 510 is the same as or similar to that of the nozzle 412 of the fourth embodiments, the end portion extending to the inner side of the outer cap 410 may become the inlet 5122, the portion communicating with the outer cap 510 becomes an outlet 5123, and the portion extending to an outside of the outer cap 610 while surrounding the outlet 5123 and having a diameter larger than the inside of the external cap 510 may become the discharge port 5121.

The support portion 520 may be spaced apart from each other around the nozzle 512 inside the outer cap 510, and may include the support column 521 and a stopper 522.

The support portion 520 of this embodiment may be structurally and functionally the same as or similar to the support portion 420 of the above-described fourth embodiments, such as having three support columns 521, and the detailed description thereof will be omitted here.

When the inner pressure of the inertial member 530 is increased by pressing the container 10, the inertial member 530 may be guided by the plurality of support columns 521 while pushing the elastic member 540 and may move toward the nozzle 512 to close the nozzle 512, and when the pressure applied to the container 10 is released, the inertial member 530 may move in the opposite direction to the nozzle 512 by the elastic force of the elastic member 540 to open the nozzle 412.

The inertial member 530 may include a main body portion 531, a guide portion 532, a plug portion 533, a groove portion 534, an annular protrusion 536, and a protrusion 537.

The basic structure of the inertial member 530 of the present embodiment may be the same as or similar to that of the above-described inertial members 430 of the fourth embodiments, and thus a detailed description thereof will be omitted herein.

However, the length of the inertial member 530 according to the present embodiment may be different from that of the above-described inertial members 430 according to the fourth embodiments.

In other words, in the present embodiment, the length of the plug portion 533 is shorter than that of the plug portion 433 of the fourth embodiments (refer to FIGS. 33 and 38), and the inertial member 530 having a shorter length of the plug portion 533 as in the present embodiment may be suitable for use when the content is as heavy as laundry detergent (viscosity of about 100 cps) and the required discharge capacity is large (e.g., 7 cc to 10 cc), or for use when the contents are as high as dyed gray hair shampoo (viscosities of about 500 cps) and is as medium as required discharge capacity (e.g., 2.5 cc). The intensity and the high viscosity may be, for example, 100 cps to 500 cps.

The elastic member 540 may be provided between the inertial member 530 and the outer cap 510, and may be structurally and functionally the same as or similar to the elastic member 440 of the fourth embodiments, so a detailed description thereof will be omitted herein.

The discharge member 550 may be coupled to the nozzle 512 and configured to discharge the contents passing through the nozzle 512 to the outside.

The discharge member 550 may include a coupling portion 551 coupled to the nozzle 412, a discharge portion 552 extending a predetermined length outward from the coupling portion 551 to discharge the contents to the outside, and a valve portion 553 opened when the container 10 is pressurized and closed when the pressurization is released.

The coupling portion 551 and the discharge portion 552 may be integral, and may have a path through which the contents flowing out from the nozzle 512 move.

The coupling portion 551 may be coupled to the nozzle 512 by a clamping coupling method or a bolting coupling method.

When the discharge port 5121 of the nozzle 512 extends to the outside of the outer cap 510 while surrounding the outlet 5123 as described above and is formed to have a larger diameter than the inside of the outer cap 5110, the coupling portion 551 may have an inner diameter corresponding to the outer diameter of the discharge port 5121 of the nozzle 512.

The discharge portion 552 extends from the coupling portion 551, but may become smaller toward the outlet side. That is, the discharge portion 552 may have a tapered shape in which the width gradually decreases as the entire shape goes toward the outlet side. The larger the amount of taper of the discharge portion 552, the smaller the size of the outlet. The outlet of the discharge portion 552 may be basically circular.

The discharge portion 552 may have a protrusion (not shown in the drawings) that is in close contact with the inner circumferential surface of the discharge port 5121 of the nozzle 512.

The valve portion 553 is installed at the upper end of the outlet 5123 so as to be accommodated inside the coupling portion 551 to open and close the outlet 5123 of the nozzle 512, but may be fixedly installed by being pressed against a protrusion formed at the inner boundary between the coupling portion 551 and the discharge portion 552 when the coupling portion 551 is coupled to the nozzle 521.

The valve portion 553 may be a disk valve. When the disc valve is applied to the inertial member 530 in which the contents are discharged in large quantities (e.g., 7 cc to 10 cc) while having a medium viscosity, such as laundry detergent (viscosity of about 100 cps), or when applied to the inertial member 530 in which the contents are discharged in medium quantities (e.g., 2.5 cc) while have a high viscosity, such as dyed gray hair shampoo (viscosities of about 500 cps), the discharge efficiency may be increased.

The state of use of the dispensing apparatus 5 containing the dispenser 500 and the container 10 according to the fifth embodiments configured as described above is the same as or similar to that described with reference to FIG. 8 in the first embodiments described above, so the description will be omitted here.

The present invention is not limited to the embodiments described above, and may include a combination of the above embodiments or a combination of at least one of the above embodiments and a known technology as another embodiment.

Although the present invention has been described above with reference to embodiments of the present invention, it is merely illustrative and not restrictive, and those skilled in the art will recognize that various combinations, modifications, and applications not illustrated in the embodiments are possible without departing from the essential technical content of the embodiments. Accordingly, descriptions related to modifications and applications that may be easily derived from embodiments of the present invention should be construed as being included in the present invention.

[Description of symbols]

| | |
|---|---|
| 1, 2, 3, 4, 5: Dispensing apparatus | 10: Container |
| 11: Container body | 12: First fastening portion |
| 20: Cap | 100: Dispenser |
| 110: Outer cap | 111: Second fastening portion |
| 112: Nozzle | 1121: Discharge port |
| 1122: Inlet | 120, 120a: Support portion |
| 121, 121a: Support column | 122: Stopper |
| 123: First inflow path | 124: Second inflow path |
| 125: Locking groove | 126: Buffer groove |
| 130, 130a, 130b: Inertial member | 131: Main body portion |
| 132: Guide portion | 133: Plug portion |
| 134: Groove portion | 135: Auxiliary guide portion |
| 136: Annular protrusion | 137: Protrusion |
| 140: Elastic member | 150: Stopper member |
| 151: Annular portion | 152: Fixing portion |
| 153: Locking jaw | 154: Hole |
| 155: Annular protrusion | 200: Dispenser |
| 210: Outer cap | 211: Second fastening portion |
| 212: Nozzle | 2121: Discharge port |
| 2122: Inlet | 213: Third fastening portion |
| 214: First protruding portion | 220: Support portion |
| 221: Fourth fastening portion | 222: Inflow path |
| 230 Inertial member | 231: Main body portion |
| 2311: First portion | 2312: Second portion |
| 232: Guide portion | |
| 2321: Second protrusion portion | |
| 233: Plug portion | 234: Groove portion |
| 240: Elastic member | 300: Dispenser |
| 310: Outer cap | 311: Second fastening portion |
| 312: Nozzle | 3121: Discharge port |
| 3122: Inlet | 313: Third fastening portion |
| 320: Housing | 321: Fourth fastening portion |
| 322: First inflow path | 323: Second inflow path |
| 330: Inertial member | 331: Main body portion |
| 332: Plug portion | 333: Groove portion |
| 334: Rib | 335: Protrusion |
| 340: Elastic member | 400: Dispenser |
| 410: Outer cap | 411: Second fastening portion |
| 412: Nozzle | 4121: Discharge port |
| 4122: Inlet | 420: Support portion |
| 421: Support column | 422: Stopper |
| 430: Inertial member | 431: Main body portion |
| 432: Guide portion | 433: Plug portion |
| 434: Groove portion | 436: Annular protrusion |
| 437: Protrusion | 440: Elastic member |

450, 450a, 450b, 450c: Discharge member
451, 451a, 451b, 451c: Coupling portion
452, 452a, 452b, 452c: Discharge portion

| | |
|---|---|
| 453: Valve portion | |
| 454a, 454b, 454c: Discharge means | 500: Dispenser |
| 510: Outer cap | 511: Second fastening portion |
| 512: Nozzle | 5121: Discharge port |
| 5122: Inlet | 5123: Outlet |
| 520: Support portion | 521: Support column |
| 522: Stopper | 530: Inertial member |
| 531: Main body portion | 532: Guide portion |
| 533: Plug portion | 534: Groove portion |
| 536: Annular protrusion | 537: Protrusion |
| 540: Elastic member | 550: Discharge member |
| 551: Coupling portion | 552: Discharge portion |
| 553: Valve portion | |

1. A dispenser comprising:
an outer cap fastened to an inlet of a container capable of increasing internal pressure by an external force and having a nozzle discharging contents contained in the container;
a support portion having a plurality of support columns spaced apart from each other around the nozzle in the outer cap;
an inertial member guided by the plurality of support columns, moving toward the nozzle when the internal pressure of the container increases, and opening and closing the nozzle; and
an elastic member pushing the inertial member away from the nozzle,
wherein a first inflow path is formed by a space between the plurality of support columns in a discharge direction of the nozzle, and
wherein the first inflow path is configured to allow the contents to press the inertial member when the internal pressure of the container increases.

2. The dispenser according to claim 1, wherein a second flow path is formed by a space between the plurality of support columns in a circumferential direction of the nozzle, and
wherein the second flow path allows the contents to flow between the inertial member and the nozzle when the inertial member moves away from the nozzle by the elastic member, or allows the contents to flow into the nozzle by a siphon effect when the inertial member moves toward the nozzle when compressing the elastic member.

3. The dispenser according to claim 1, wherein the nozzle includes a discharge port protruding toward an outside of the container and an inlet protruding toward an inside of the container,
wherein the inertial member includes a plug portion moving toward the nozzle to contact the inlet and close the nozzle,
wherein the plug portion has a shape in which cross-section becomes smaller in a direction toward the nozzle, and
wherein the inlet has a shape corresponding to the shape of the plug portion.

4. The dispenser according to claim 3, wherein a discharge amount of the contents is adjusted by adjusting a distance between the plug portion and the nozzle, and
wherein the discharge amount of the contents becomes greater when the distance between the plug portion and the nozzle becomes greater.

5. The dispenser according to claim 4, wherein the distance between the plug portion and the nozzle is adjusted according to a length of the plug portion or a length of the plurality of support columns.

6. The dispenser according to claim 1, wherein the inertial member includes:
a cylindrical main body portion having one side facing the nozzle being open and an other side facing the container being closed;
a guide portion provided on an outer peripheral surface of the main body portion to correspond to the plurality of support columns;
a plug portion having a shape in which a cross-section becomes smaller in a direction from the main body portion toward the nozzle; and
a groove portion provided on an other side surface of the main body portion and having a shape corresponding to the cross-section of the plug portion.

7. The dispenser according to claim 6, wherein the inertial member further includes at least one of an auxiliary guide portion guiding an ascending and descending of the support column and a protrusion increasing a surface area to which the contents press when the internal pressure of the container increases,
wherein the auxiliary guide portion has a rod shape extending in a longitudinal direction of the support column in the guide portion, and
wherein the protrusion protrudes from the outer peripheral surface of the main body portion and has a groove on a side facing the container.

8. The dispenser according to claim 7, wherein the main body portion has a discontinuous cylindrical shape in which a portion corresponding to the plurality of support columns is cut out,
wherein the guide portion is provided on an edge of the closed other side of the main body portion to minimize friction with the plurality of support columns during a vertical movement of the inertial member, and
wherein the protrusion extends from one end to an other end of the main body portion to compensate for a strength of the main body having the discontinuous cylindrical shape.

9. The dispenser according to claim 7, wherein the plurality of support columns are formed of four columns by providing one at each vertex of a rectangle or formed of three columns by providing one at each vertex of a triangle.

10. The dispenser according to claim 1, wherein the support portion is integrally formed with the outer cap, and includes a stopper provided on an end of at least one of the plurality of support columns facing each other, and
wherein the stopper is implemented in a heat fusion or an injection and prevents the inertial member from disengaging when the inertial member moves away from the nozzle by the elastic member.

11. The dispenser according to claim 1, wherein the support portion is integrally formed with the outer cap, and
wherein the support portion includes:
the plurality of support columns spaced apart from each other around the nozzle in an inner side of the outer cap;
a locking groove provided concavely in at least a portion of an inner side surface of an end of the plurality of support columns facing each other; and
a buffer groove formed by cutting the end of the plurality of support columns with the locking groove to a predetermined depth.

12. The dispenser according to claim 11, further comprising:
a stopper member preventing the inertial member from being detached when the elastic member moves away from the nozzle,
wherein the stopper member includes:
an annular portion having a ring shape corresponding to the inertial member and in contact with the inertial member;
a plurality of fixing portions protruding outwardly from positions corresponding to the plurality of support columns to an outside of the annular portion so that the annular portion is fixed to the plurality of the support columns;
a locking jaw protruding outwardly from the fixing portion and inserted into the locking groove at a position corresponding to the support column in which the locking groove is provided among the plurality of support columns; and
a hole including a plurality of holes and through which a portion of the annular portion in which the plurality of fixing portions are located penetrates, wherein the plurality of holes allow the contents to pressurize the inertial member when the internal pressure of the container increases.

13. The dispenser according to claim 1, further comprising:
a discharge member coupled to the nozzle to discharge the contents passing through the nozzle to the outside,
wherein the discharge member includes:
a coupling portion coupled to the nozzle;
a discharge portion extending outwardly from the coupling portion by a predetermined length to discharge the contents to the outside; and
a valve portion opened when the container is pressurized and closed when the container is released.

14. The dispenser according to claim 1, wherein the valve portion includes a silicon valve or a disk valve,
wherein the silicon valve is used when the contents have a low viscosity and a required discharge amount is small, and
wherein the disk valve is used when the contents have a high viscosity and the discharge amount is large.

15. A dispenser comprising:
an outer cap fastened to an inlet of a container capable of increasing internal pressure by an external force and having a nozzle discharging contents contained in the container;
a support portion provided around the nozzle in the outer cap;
an inertial member moving toward the nozzle when the internal pressure of the container increases, and opening and closing the nozzle; and
an elastic member pushing the inertial member away from the nozzle,
wherein the support portion includes:
a fourth fastening portion provided on an outer peripheral surface and fastened to the outer cap; and
a plurality of inflow paths formed by penetrating the outer peripheral surface at regular intervals in a circumferential direction of the nozzle.

16. The dispenser according to claim 15, wherein the outer cap includes:
a second fastening portion fastened to a first fastening portion of the container; and
a third fastening portion provided between the second fastening portion and the nozzle and fastened to the fourth fastening portion of the support portion.

17. The dispenser according to claim 15, wherein the nozzle includes a discharge port protruding toward an outside of the container, and an inlet protruding toward an inside of the container,
wherein the inertial member includes a plug portion moving toward the nozzle to contact the inlet and close the nozzle,
wherein the plug portion has a shape in which a cross-section becomes smaller in a direction toward the nozzle, and
wherein the inlet has a shape corresponding to the shape of the plug portion.

18. The dispenser according to claim 15, wherein the inertial member includes:
a main body portion having a cylindrical shape in which one side facing the nozzle and the other side facing the container are open, the main body portion being divided into a first portion facing the nozzle and a second portion facing the inside of the container;
a guide portion provided on an inner peripheral surface of the first portion of the main body portion to guide movement of the body portion with respect to the nozzle;
a plug portion provided in the main body portion between the first portion and the second portion, the plug portion having a shape in which a cross-section becomes smaller in a direction toward the nozzle; and
a groove portion having a shape corresponding to a cross-section of the plug portion in the second portion.

19. The dispenser according to claim 15, wherein the plurality of inflow paths of the support portion is configured to allow the contents to be introduced into the first portion when the inertial member moves away from the nozzle by the elastic member, or the contents to be transferred to the nozzle by a siphon effect when the inertial member moves toward the nozzle while compressing the elastic member.

20. The dispenser according to claim 15, wherein the support portion, the inertial member, and the elastic member are integrally formed of one material.

21. The dispenser according to claim 20, wherein the elastic member is provided on an outer periphery of the inertial member, and
one end of the elastic member is connected to the support portion and an other end is connected to the inertial member.

22. A dispensing apparatus comprising: the dispenser of claim 1; and
a container mounted to the dispenser.

23. The dispensing apparatus according to claim 22, including contents contained in the container.
